(19) United States
(12) Patent Application Publication
(10) Pub. No.: US 2025/0115698 A1
(43) Pub. Date: Apr. 10, 2025

(54) CURABLE FORMULATIONS FOR POLISHING PADS

(71) Applicant: Applied Materials, Inc., Santa Clara, CA (US)

(72) Inventors: Xinyi Lu, Santa Clara, CA (US); SeyedMahmoud Hosseini, San Jose, CA (US); Sudhakar Madhusoodhanan, San Jose, CA (US); Srikant Pathak, Diamond Bar, CA (US)

(73) Assignee: Applied Materials, Inc., Santa Clara, CA (US)

(21) Appl. No.: 18/483,363

(22) Filed: Oct. 9, 2023

(51) Int. Cl. C08F 222/10; B24D 18/00; B33Y 10/00; B33Y 70/00; C08F 2/50

(52) U.S. Cl. CPC C08F 222/1065; B24D 18/00; B33Y 10/00; B33Y 70/00; C08F 2/50

(57) ABSTRACT

Printable resin precursor compositions and polishing articles including printable resin precursors are provided. Printable resin precursors include a curable precursor formulation having a viscosity of less than or about 15 cP at 70° which include at least one urethane acrylate oligomer, at least one reactive monomer, and a photoinitiator. The curable precursor formulation exhibits an ultimate tensile strength measured in mPa and an elongation at break (%), where a product of the ultimate tensile strength and the elongation at break is greater than or about 2,000.

### TECHNICAL FIELD

The present technology relates to components and apparatuses for semiconductor manufacturing. More specifically, the present technology relates to formulations and compositions for polishing articles that exhibited improved process margins.

### BACKGROUND

Chemical mechanical polishing (CMP) is a conventional process that has been used in many different industries to planarize surfaces of substrates. In the semiconductor industry, uniformity of polishing and planarization has become increasingly notable as device feature sizes continue to decrease. During a CMP process, a substrate, such as a silicon wafer, is mounted on a carrier head with the device surface placed against a rotating polishing pad. The carrier head provides a controllable load on the substrate to push the device surface against the polishing pad. A polishing liquid, such as slurry with abrasive particles, is typically supplied to the surface of the moving polishing pad and polishing head. The polishing pad and polishing head apply mechanical energy to the substrate, while the pad also helps to control the transport of slurry, which interacts with the substrate during the polishing process. However, current polishing pads are formed utilizing materials with low elongation, ultimate tensile strength, toughness, modulus, and the like, due to limitations in machining the polishing pads, resulting in polishing pads with non-uniform polishing and poor property tuning. In addition, existing machining methods result in a high degree of variability in the produced pads, also contributing to undesirable pad properties.

Thus, there is a need for improved polishing pad materials and methods that can be used to produce high quality polishing articles. These and other needs are addressed by the present technology.

### BRIEF SUMMARY

The present technology is generally directed to printable resin precursor compositions, and printed pads formed therefrom. Compositions include a curable precursor formulation having a viscosity of less than or about 15 cP at 70°. Curable precursor formulations include at least one aliphatic urethane acrylate oligomer having a Young's Modulus of greater than or about 1 MPa, a first reactive monomer having a first glass transition temperature and a first reactive monomer viscosity at 25° C., a second reactive monomer having a second glass transition temperature and a second reactive monomer viscosity 25° C., and a photoinitiator. Compositions include where an average of the first glass transition temperature and the second glass transition temperature is less than or about 70° C., an average of the first reactive monomer viscosity and the second reactive monomer viscosity is less than or about 50 cP at 25° C., or a combination thereof.

In embodiments, compositions include where the at least one aliphatic urethane acrylate oligomer exhibits an elongation at break of greater than or about 50%. In more embodiments, the at least one aliphatic urethane acrylate oligomer exhibits an elongation at break of greater than or about 75%. Furthermore, in embodiments, the at least one aliphatic urethane acrylate oligomer exhibits a tensile strength of greater than or about 5 MPa. In yet more embodiments, the at least one aliphatic urethane acrylate oligomer exhibits a Young's Modulus of greater than or about 10 MPa. Additionally or alternatively, in embodiments, the at least one aliphatic urethane acrylate oligomer is an aliphatic urethane diacrylate oligomer, an aliphatic polyester urethane diacrylate oligomer, an aliphatic polyether urethane diacrylate oligomer, or a combination thereof. In more embodiments, the at least one aliphatic urethane acrylate oligomer has a molecular weight of less than or about 5000 g/mol.

Embodiments include where the first reactive monomer exhibits a viscosity of greater than or about 5 cP at 25° C. In embodiments, the second reactive monomer exhibits a viscosity of less than or about 5 cP at 25° C. moreover, in embodiments, the second reactive monomer exhibits a viscosity of less than or about 2.5 cP at 25° C. In yet further embodiments, the first reactive monomer exhibits a glass transition temperature of greater than or about 55°. In embodiments, the first reactive monomer exhibits a glass transition temperature of greater than or about 80°. Embodiments include where the second reactive monomer exhibits a glass transition temperature of less than or about 55°. In embodiment, the second reactive monomer exhibits a glass transition temperature of less than or about 40°. In embodiments, the first reactive monomer, the second reactive monomer, or both the first and second reactive monomer is isobornyl acrylate, 3,3,5-trimethylcyclohexyl acrylate, N-vinyl-2-pyrrolidone, N,N-diethyl acrylamide, (2-[[(butylamino)carbonyl]oxy]ethyl acrylate), acrylic acid, methacrylic acid, 2-carboxyethyl acrylate, 2-hydroxyethyl methacrylate, 2-hydroxyethyl acrylate, N-(2-hydroxyethyl)acrylamide, tetrahydrofurfuryl acrylate, cyclohexyl acrylate, cyclic trimethylolpropane formal acrylate, pentaerythritol tetra (3-mercaptopropionate), ethylene Glycol Bis(3-mercaptopropionate), or a combination thereof. In more embodiments, the first reactive monomer, the second reactive monomer, or both the first and second reactive monomer is isobornyl acrylate, 3,3,5-trimethylcyclohexyl acrylate, N-vinyl-2-pyrrolidone, N,N-diethyl acrylamide, (2-[[(butylamino)carbonyl]oxy]ethyl acrylate), N-(2-hydroxyethyl)acrylamide, or a combination thereof. Moreover, in embodiments, the first reactive monomer is isobornyl acrylate, N,N-diethyl acrylamide, N-(2-hydroxyethyl)acrylamide, or a combination thereof. Embodiments include where the second reactive monomer is 3,3,5-trimethylcyclohexyl acrylate, N-vinyl-2-pyrrolidone, (2-[[(butylamino)carbonyl]oxy]ethyl acrylate), or a combination thereof.

The present technology is also generally directed to printable resin precursor compositions. Compositions include a curable precursor formulation having a viscosity of less than or about 15 cP at 70°. Curable precursor formulations include a first aliphatic urethane acrylate oligomer having a Young's Modulus of greater than or about 10 MPa, a first reactive monomer having a first glass transition temperature and a first reactive monomer viscosity, a second reactive monomer having a second glass transition temperature and a second reactive monomer viscosity, and a photoinitiator.

The present technology is also generally directed to methods of forming a polishing article. Methods include depositing one or more droplets of a curable precursor formulation onto a support with an additive manufacturing system, where the curable precursor formulation exhibits a viscosity of less than or about 15 cP at 70°. The curable precursor formulation includes at least one aliphatic urethane acrylate oligomer having a Young's Modulus of greater than or about 1 MPa, a first reactive monomer having a first glass transition temperature and a first reactive monomer viscosity, a second reactive monomer having a second glass transition temperature and a second reactive monomer viscosity, and a photoinitiator. Methods include curing the precursor formulation, forming one or more solidified polymeric layers.

### BRIEF DESCRIPTION OF THE DRAWINGS

A further understanding of the nature and advantages of the disclosed technology may be realized by reference to the remaining portions of the specification and the drawings.

FIG. 1 shows a schematic cross-sectional view of an exemplary processing system according to embodiments of the present technology.

FIG. 2A is a schematic isometric and cross-sectional view of an advanced polishing pad according to embodiments of the present technology;

FIG. 2B is a schematic partial top view of an advanced polishing pad according to an embodiments of the present technology;

FIG. 2C is a schematic isometric and cross-sectional view of an advanced polishing pad according to embodiments of the present technology;

FIG. 2D is a schematic side cross-sectional view of a portion of an advanced polishing pad according to embodiments of the present technology;

FIG. 2E is a schematic side cross-sectional view of a portion of an advanced polishing pad according to embodiments of the present technology;

FIGS. 2F-2K are top views of advanced polishing pad designs according to embodiments of the present technology.

FIG. 3A is a schematic view of a system for manufacturing advanced polishing pads, according to embodiments of the present technology;

FIG. 3B is a schematic view of a portion of the system illustrated in FIG. 3A, according to embodiments of the present technology;

FIG. 3C is a schematic view of a dispensed droplet disposed on a surface of a region of the advanced polishing pad according to embodiments of the present technology;

FIG. 4 is a flow chart depicting a method of forming a polishing article according to embodiments of the present technology.

Several of the figures are included as schematics. It is to be understood that the figures are for illustrative purposes and are not to be considered of scale unless specifically stated to be of scale. Additionally, as schematics, the figures are provided to aid comprehension and may not include all aspects or information compared to realistic representations and may include exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter.

### DETAILED DESCRIPTION

Chemical-mechanical polishing (CMP) often includes a multi-component system including a polishing assembly and a carrier head. A semiconductor substrate may be clamped into the carrier head, inverted, and depressed against a polishing pad on the polishing assembly. When non-uniform features or multiple films characterized by different physical properties are being removed, some systems may be able to modulate the pressure at which different zones of the substrate contact the polishing pad. For example, the carrier head may include chambers in which a pressure may be adjusted to increase or decrease a pressure applied to the substrate in that region. Similarly, a retaining ring extending outside of the substrate can be pressed with increased or decreased pressure to impact an overall effect on the substrate.

Polishing pads are typically made from compositions or formulations that include viscoelastic polymeric materials. The mechanical properties of a polishing pad (e.g., elasticity, rebound, hardness, and stiffness) which are impacted by the polymeric formulations, and the CMP processing conditions have a significant impact on the CMP polishing performance on both an integrated circuit (“IC”) die level (microscopic/nanoscopic) and wafer or global level (macroscopic). For example, CMP process forces and conditions, such as pad compression, pad rebound, friction, and changes in temperature during processing, and abrasive aqueous slurry chemistries will impact polishing pad properties and thus CMP performance.

Conventional polishing pads are typically formed via molding, casting, or sintering polymeric materials that generally include polyurethane materials. In the case of molding, an example of which is injection molding, polishing pads are made one at a time. In the case of casting, the liquid precursor is cast and cured into a cake, which is subsequently sliced into individual pad pieces. These pad pieces are then be machined to a final thickness. Pad surface features, including grooves, which aid in slurry transport, can be machined into the polishing surface, or be formed as part of the injection molding process. However, conventional methods of manufacturing polishing pads are expensive and time consuming, and often yield non-uniform polishing results due to the difficulties in the production and control of the feature dimensions of the pad surface. Non-uniformity has become increasingly notable as the dimensions of IC dies and features continue to shrink.

Current pad materials and their manufacturing methods limit the manipulation and fine control of bulk pad properties such as elongation, ultimate tensile strength, toughness, and modulus of the cured or hardened polymeric material, which each play a role in pad performance. Namely, conventional pad production via traditional bulk polymerization and casting and molding techniques only provides limited control of pad process margin properties, as the pad is a random mixture of phase separated macromolecular domains that are subject to intramolecular repulsive and attractive forces and variable polymer chain entanglement. For example, the presence of phase separated micro and macroscopic structural domains in the bulk pad may yield an additive combination of non-linear material responses, such as a hysteresis in the storage modulus over multiple heating and cooling cycles that typically occur during the CMP processing of batches of substrates, which may result polishing non-uniformities and unpredictable performance across the batch of substrates.

Other manufacturing methods and processes have been explored for formation for CMP pads in order to overcome these deficiencies. For example, attempts have been made to utilize additive manufacturing in order to provide highly uniform CMP pads with improved and varied process margin properties. However, existing polymeric formulations for CMP pad formation exhibit unacceptably high viscosities for additive manufacturing, such as above 15 cP at printing conditions (such as about 70° C.) and/or above 250 cP at ambient conditions (such as about 23° C.). Furthermore, even if suitable viscosities were obtained, such formulations failed to provide the desired toughness, tensile strength, and/or elongation properties to the CMP pads, due to modifications necessary to control viscosity.

The present technology has surprisingly found that by utilizing a unique combination that includes a urethane oligomer having a high Young's modulus, in combination with a reactive monomer component having uniquely tailored glass transition temperatures and viscosity, a curable precursor formulation may be provided that exhibits improved strength and elongation, as examples, while also maintaining excellent printing viscosities. Namely, the present technology has surprisingly found that carefully selected aliphatic urethane acrylate oligomers may contribute high strength to the cured product, allowing for improved wear properties. Furthermore, by utilizing one or more reactive monomers, a reactive monomer component may be uniquely formed that provides excellent elongation and viscosity to the curable precursor formulation. Thus, in embodiments, formulations according to the present technology may be well suited for forming CMP pads and other semiconductor components due at least in part to their excellent toughness, tensile strength, and elongation, as well as their ability to be readily printed via additive manufacturing.

Although the remaining disclosure will routinely identify specific polishing pads and methods of forming such pads utilizing the disclosed technology, it will be readily understood that the systems and methods are equally applicable to a variety of other chemical-mechanical polishing processes and systems, as well as methods of forming such articles. Accordingly, the technology should not be considered to be so limited as for use with the described polishing systems or processes alone. The disclosure will discuss one possible system that can be used with the present technology before describing systems and methods or operations of exemplary process sequences according to some embodiments of the present technology. It is to be understood that the technology is not limited to the equipment described, and processes discussed may be performed in any number of processing chambers and systems, along with any number of modifications, some of which will be noted below.

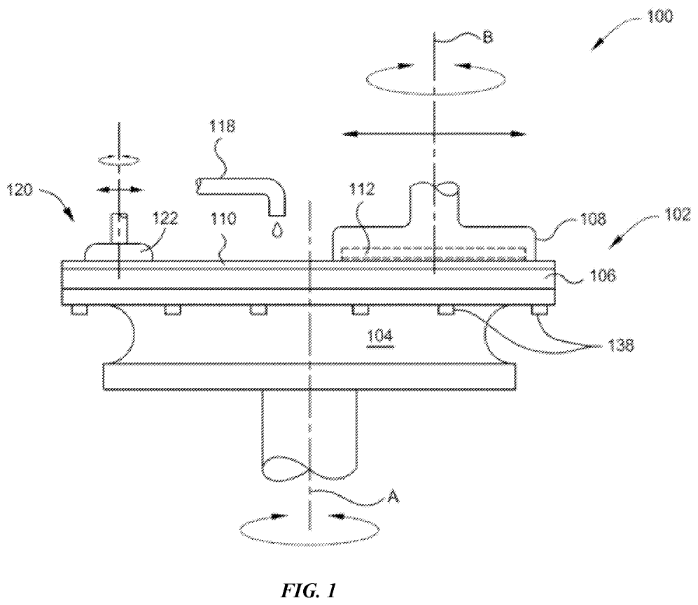

FIG. 1 shows a schematic cross-sectional view of an exemplary polishing system 100 according to some embodiments of the present technology. Polishing system 100 includes a platen assembly 102, which includes a lower platen 104 and an upper platen 106. Lower platen 104 may define an interior volume or cavity through which connections can be made, as well as in which may be included end-point detection equipment or other sensors or devices, such as eddy current sensors, optical sensors, or other components for monitoring polishing operations or components. For example, and as described further below, fluid couplings may be formed with lines extending through the lower platen 104, and which may access upper platen 106 through a backside of the upper platen. Platen assembly 102 may include a polishing pad 110 mounted on a first surface of the upper platen. A substrate carrier 108, or carrier head, may be disposed above the polishing pad 110 and may face the polishing pad 110. The platen assembly 102 may be rotatable about an axis A, while the substrate carrier 108 may be rotatable about an axis B. The substrate carrier may also be configured to sweep back and forth from an inner radius to an outer radius along the platen assembly, which may, in part, reduce uneven wear of the surface of the polishing pad 110. The polishing system 100 may also include a fluid delivery arm 118 positioned above the polishing pad 110, and which may be used to deliver polishing fluids, such as a polishing slurry, onto the polishing pad 110. Additionally, a pad conditioning assembly 120 may be disposed above the polishing pad 110 and may face the polishing pad 110.

In some embodiments of performing a chemical-mechanical polishing process, the rotating and/or sweeping substrate carrier 108 may exert a downforce against a substrate 112, which is shown in phantom and may be disposed within or coupled with the substrate carrier. The downward force applied may depress a material surface of the substrate 112 against the polishing pad 110 as the polishing pad 110 rotates about a central axis of the platen assembly. The interaction of the substrate 112 against the polishing pad 110 may occur in the presence of one or more polishing fluids delivered by the fluid delivery arm 118. A typical polishing fluid may include a slurry formed of an aqueous solution in which abrasive particles may be suspended. Often, the polishing fluid contains a pH adjuster and other chemically active components, such as an oxidizing agent, which may enable chemical mechanical polishing of the material surface of the substrate 112.

The pad conditioning assembly 120 may be operated to apply a fixed abrasive conditioning disk 122 against the surface of the polishing pad 110, which may be rotated as previously noted. The conditioning disk may be operated against the pad prior to, subsequent, or during polishing of the substrate 112. Conditioning the polishing pad 110 with the conditioning disk 122 may maintain the polishing pad 110 in a desired condition by abrading, rejuvenating, and removing polish byproducts and other debris from the polishing surface of the polishing pad 110. Upper platen 106 may be disposed on a mounting surface of the lower platen 104 and may be coupled with the lower platen 104 using a plurality of fasteners 138, such as extending through an annular flange shaped portion of the lower platen 104.

The polishing platen assembly 102, and thus the upper platen 106, may be suitably sized for any desired polishing system, and may be sized for a substrate of any diameter, including 200 mm, 300 mm, 450 mm, or greater. For example, a polishing platen assembly configured to polish 300 mm diameter substrates, may be characterized by a diameter of more than about 300 mm, such as between about 500 mm and about 1000 mm, or more than about 500 mm. The platen may be adjusted in diameter to accommodate substrates characterized by a larger or smaller diameter, or for a polishing platen 106 sized for concurrent polishing of multiple substrates. The upper platen 106 may be characterized by a thickness of between about 20 mm and about 150 mm and may be characterized by a thickness of less than or about 100 mm, such as less than or about 80 mm, less than or about 60 mm, less than or about 40 mm, or less. In some embodiments, a ratio of a diameter to a thickness of the polishing platen 106 may be greater than or about 3:1, greater than or about 5:1, greater than or about 10:1, greater than or about 15:1, greater than or about 20:1, greater than or about 25:1, greater than or about 30:1, greater than or about 40:1, greater than or about 50:1, or more.

The upper platen and/or the lower platen may be formed of a suitably rigid, lightweight, and polishing fluid corrosion-resistant material, such as aluminum, an aluminum alloy, or stainless steel, although any number of materials may be used. Polishing pad 110 may be formed of any number of materials, including polymeric materials, such as polyurethane, a polycarbonate, fluoropolymers, polytetrafluoroethylene polyphenylene sulfide, or combinations of any of these or other materials. Additional materials may be or include open or closed cell foamed polymers, elastomers, felt, impregnated felt, plastics, or any other materials that may be compatible with the processing chemistries. It is to be understood that polishing system 100 is included to provide suitable reference to components discussed below, which may be incorporated in system 100, although the description of polishing system 100 is not intended to limit the present technology in any way, as embodiments of the present technology may be incorporated in any number of polishing systems that may benefit from the components and/or capabilities as described further below.

In embodiments, formulations discussed herein may be utilized in an additive manufacturing process, such as a three-dimensional printing (or 3-D printing) process may be used to form the polishing articles according to the present technology. In embodiments, a model, such as a computer (CAD) model as an example, of the article is produced, after which a slicing algorithm maps the information for each layer. In one non-limiting example of a 3-D printing process, the 3-D printing process is a process in which droplets of a liquid polymer formulation, such as the formulations discussed below, are dispensed on a surface and are then cured to form the polishing article in layer-by-layer fashion, which is discussed further below. Since 3-D printing processes can exercise local control over the material composition, microstructure and surface texture, various (and previously inaccessible) geometries may be achieved with this method.

In embodiments, a polishing article formed according to the present technology may be represented in a data structure readable by a computer rendering device or a computer display device. The computer-readable medium may contain a data structure that represents the polishing article. The data structure may be a computer file, and may contain information about the structures, materials, textures, physical properties, or other characteristics of one or more articles. The data structure may also contain code, such as computer executable code or device control code that engages selected functionality of a computer rendering device or a computer display device. The data structure may be stored on the computer-readable medium. The computer-readable medium may include a physical storage medium such as a magnetic memory, floppy disk, or any convenient physical storage medium. The physical storage medium may be readable by the computer system to render the article represented by the data structure on a computer screen or a physical rendering device, which may be an additive manufacturing device, such as a 3D printer.

Typical cross-linked networks obtained by UV-curable ethylenically unsaturated moieties are very brittle and have very low elongation-at-break. Embodiments described herein provide unique compositions formed from curable precursor formulations well suited for forming advanced chemical mechanical planarization (CMP) pads, such as polishing articles that may be utilized for semiconductor fabrication. The formulations and compositions disclosed herein may be cross-linked by ultraviolet (UV) light to form a network structure or may be cross linked by other curing methods as known in the art and may therefore be referred to as curable precursor formulations. Furthermore, the formulations described herein may include ethylenically unsaturated monomers, oligomers and/or polymers. The formulations described herein may be used in an additive manufacturing (3D printing) process to make polishing articles, for example by jetting the ink through a printhead, as well as other additive manufacturing processes that will be discussed in greater detail below. The formulations for polishing pads described herein surprisingly exhibit higher elongation-at-break and toughness at room temperature while maintaining the targeted storage modulus at 30° C. (E30) and 90° C. (E90) and ultimate tensile stress (UTS) at room temperature for good polishing performance.

In embodiments, the resin precursor composition may include at least one curable precursor formulation. The resin precursor may be well suited for use in additive manufacturing and may therefore be referred to as a printable resin precursor. The resin precursor composition may include at least one of: one or more oligomer components, one or more monomer components, one or more crosslinking agents, one or more photoinitiator components, one or more emulsifiers/surfactants, one or more inorganic particles, organic particles or both, one or more porosity forming agents; and one or more additional additives. Namely, as discussed above, the present technology has surprisingly found that by utilizing an aliphatic urethane acrylate oligomer with a high Young's modulus, alone or in combination with a reactive monomer component having tailored glass transition temperature and viscosity properties, a unique well tailored curable precursor formulation may be formed with excellent printing properties. Furthermore, such curable precursor formulations may provide one or more optimal printed article properties as discussed herein.

The present disclosure has surprisingly found that by utilizing oligomers and monomers combinations having carefully tailored properties, curable precursor formulations can be provided with excellent toughness and elongation while maintaining their suitability for printing. Namely, curable precursor formulations according to the present technology exhibit a viscosity of less than or about 15 cP at 70°, such as less than or about 14 cP at 70°, such as less than or about 13 cP at 70°, such as less than or about 12.5 cP at 70°. Thus, the provided formulations having excellent printing qualities that minimize printing defects and facilitate more uniform and robust printing than formulations that require high printing temperatures or more than one printing temperature.

Furthermore, curable precursor formulations according to the present technology also exhibit favorable viscosities at room temperature. For instance, formulations according to the present technology may exhibit a viscosity of less than 250 cP at 23° C., such as less than or about 225 cP at 23° C., such as less than or about 200 cP at 23° C., such as less than or about 175 cP at 23° C., such as less than or about 150 cP at 23° C., such as less than or about 125 cP at 23° C., such as less than or about 100 cP at 23° C., such as less than or about 75 cP at 23° C., such as even less than or about 50 cP at 23° C.

In addition, as noted above, formulations discussed herein may exhibit an elongation at break, measured according to ASTM D638 (2023), of greater than or about 60%, such as greater than or about 70%, such as greater than or about 80%, such as greater than or about 85%, such as greater than or about 90%, such as greater than or about 95%, such as greater than or about 100%, such as greater than or about 110%, such as greater than or about 120%, such as greater than or about 130%, such as greater than or about 140%, such as greater than or about 150%, such as greater than or about 160%, such as greater than or about 170%, such as greater than or about 180%, such as greater than or about 190%, such as greater than or about 200%, such as greater than or about 250%, such as greater than or about 300%, such as greater than or about 350%, such as greater than or about 400%, such as greater than or about 450%, such as greater than or about 500%, such as greater than or about 600%, such as greater than or about 700%, such as greater than or about 800%, such as even up to or about 900%, or any ranges or valued therebetween.

Moreover, the formulations according to the present technology may exhibit an ultimate tensile strength, measured according to ASTM D638 (2023), of greater than or about 10 mPa, such as greater than or about 12.5 mPa, such as greater than or about 15 mPa, such greater than or about 17.5 mPa, such as greater than or about 20 mPa, such as greater than or about 22.5 mPa, such as greater than or about 25 mPa, such as greater than or about 27.5 mPa, such as greater than or about 30 mPa, such as greater than or about 32.5 mPa, such as greater than or about 35 mPa, such as greater than or about 37.5 mPa, such as greater than or about 40 mPa, or such as less than or about 100 mPa, such as less than or about 90 mPa, such as less than or about 80 mPa, such as less than or about 70 mPa, such as less than or about 60 mPa, such as less than or about 50 mPa, or any ranges or values therebetween.

Namely, the present technology has surprisingly found that curable precursor formulations according to the present technology exhibit both excellent elongation and superior ultimate tensile strength. Thus, formulations discussed herein may be referred to as having excellent “toughness”, used herein to describe the area under the stress/strain curve. Nonetheless, in embodiments, in embodiments, the curable precursor formulation exhibits an ultimate tensile strength measured in mPa and an elongation at break measured in %, wherein a product of the ultimate tensile strength and the elongation at break is greater than or about 2,000 (mPa*%, but may also be displayed as unitless herein), such as greater than or about 2,100, such as greater than or about 2,200, such as greater than or about 2,300, such as greater than or about 2,400, such as greater than or about 2,500, such as greater than or about 2,600, such as greater than or about 2,700, such as greater than or about 2,800, such as greater than or about 2,900, such as greater than or about 3,000, such as greater than or about 3,100, such as greater than or about 3,200, such as greater than or about 3,300, such as greater than or about 3,400, such as greater than or about 3,500, such as greater than or about 3,600, such as greater than or about 3,700, such as greater than or about 3,800, such as greater than or about 3,900, such as greater than or about 4,000, or any ranges or values therebetween. Thus, it should be clear that, in embodiments, formulations according to the present technology may exhibit both excellent elongation and ultimate tensile strength without sacrificing the viscosity necessary for excellent printing.

Furthermore, curable precursor formulations according to the present technology may also exhibit a Young's Modulus of greater than or about 250 mPa, such as greater than or about 500 mPa, such as greater than or about 750 mPa, such as greater than or about 1000 mPa, such as greater than or about 1,250 mPa, such as greater than or about 1,500 mPa, such as greater than or about 1,750 mPa, such as greater than or about 2,000 mPa, such as greater than or about 2,250 mPa, such as even up to about 2,500 mPa, or any ranges or values therebetween.

Surprisingly, curable precursor formulations discussed herein may also exhibit a phenomenon referred to as “strain hardening”. As used herein, “strain hardening” refers to a material that exhibits a higher tensile strength at maximum elongation (e.g. elongation at break) than the ultimate tensile strength. Thus, in embodiments, the curable precursor formulation exhibits an ultimate tensile strength and an elongation at break, where a tensile strength of the curable precursor formulation at the elongation at break is greater than or equal to the ultimate tensile strength, such as greater than or about 2.5% higher than the ultimate tensile strength, such as greater than or about 5% higher, such as greater than or about 7.5% higher, such as greater than or about 10% higher than the ultimate tensile strength, or any ranges or values therebetween.

Nonetheless, in embodiments, the resin precursor composition includes one or more oligomer components. In embodiments, the oligomer component may be a mono or multifunctional urethane acrylate oligomer that includes a curable organic material. For instance, in embodiments, the semi-crystalline radiation curable oligomeric material may be an aliphatic polyester urethane acrylate or (meth)acrylate, an aliphatic polycarbonate urethane acrylate or (meth)acrylate, an aliphatic polyether urethane acrylate or (meth)acrylate, an aliphatic polybutadiene urethane acrylate or (meth)acrylate, or combinations thereof.

The curable oligomeric material may be mono-functional or multi-functional (e.g., di-functional, tri-functional, or greater). For instance, in embodiments, the curable oligomeric material may exhibit a functionality of greater than 1, such as greater than or about 1.1, such as greater than or about 1.2, such as greater than or about 1.3, such as greater than or about 1.4, such as greater than or about 1.5, such as greater than or about 1.6, such as greater than or about 1.7, such as greater than or about 1.8, such as greater than or about 1.9, such as greater than or about 2, such as greater than or about 3, such as greater than or about 4, such as greater than or about 5, such as greater than or about 10, or such as less than or about 10, such as less than or about 8, such as less than or about 6, such as less than or about 5, such as less than or about 4, such as less than or about 2, such as less than or about 2, or any ranges or values therebetween.

In embodiments, the curable oligomeric material may contain more than two acrylates. The one or more oligomer components may therefore include at least one of an acrylic oligomers, a urethane (meth)acrylate oligomer, a polyester based (meth)acrylate oligomer, a polyether based (meth)acrylate oligomer, a silicone based meth(acrylate), vinyl(meth)acrylates, an epoxy (meth)acrylate oligomer or any of the other oligomer components described herein. In embodiments, at least one aliphatic urethane acrylate oligomer is an aliphatic urethane diacrylate oligomer, an aliphatic polyester urethane diacrylate oligomer, an aliphatic polyether urethane diacrylate oligomer, or a combination thereof. In embodiments, the oligomer component may contain one or more urea groups attached to the end functional acrylate moieties. Further, in embodiments, the oligomer components may contain crystalline or liquid crystalline groups to improve ordering upon crosslinking that may assist in providing higher elongation and modulus.

The oligomer components may have other hydrogen bonding groups like urea and carboxylic acids to improve intermolecular and intramolecular interaction and modulus of the cross-linked pad material. In embodiments, the urethane acrylate group may contain one or more long chain alkyl groups that form a controlled network structure to improve elongation and modulus of the cross-linked film.

Examples of suitable aliphatic urethane acrylate oligomers include, but are not limited to, those under the designations of BOMAR® BR-744SD aliphatic polyester urethane diacrylate oligomer, BOMAR® BR-743S aliphatic polyester urethane diacrylate oligomer, BOMAR® BR-743SD aliphatic polyester urethane diacrylate oligomer, aliphatic urethane diacrylates from Sartomer® designated CN959, CN962, CN965, CN986, CN996, CN9024, CN991, and aliphatic urethan diacrylates from Allnex® designated Ebecryl 250 (Eb250), Ebecryl 270 (Eb270), and combinations thereof.

The one or more oligomer components may be included in the printable resin precursor composition in relatively high loading levels. For instance, in embodiments each urethane acrylate oligomer or the oligomer component containing one or more urethane acrylate oligomers may be present in the curable precursor formulation or the printable resin precursor composition in an amount of greater than or about 5 wt. %, such as greater than or about 10 wt. %, such as greater than or about 15 wt. %, such as greater than or about 20 wt. %, such as greater than or about 25 wt. %, such as greater than or about 30 wt. %, such as greater than or about 35 wt. %, such as greater than or about 40 wt. %, such as greater than or about 45 wt. %, such as greater than or about 50 wt. %, such as greater than or about 55 wt. % based on the total weight of the curable precursor formulation or the printable resin precursor composition, or any ranges or values therebetween The amount of the oligomer component in the curable precursor formulation or the printable resin precursor composition may be from about 5 wt. % to about 60 wt. % based on the total weight of the resin precursor composition such as from about 10 wt. % to about 60 wt. %, such as from about 10 wt. % to about 50 wt. %, such as from about 15 wt. % to about 45 wt. %, or from about 17.5 wt. % to about 40 wt. %, or any ranges or values therebetween or discussed above.

Moreover, in embodiments, the oligomer component may be of low viscosity, low volatility, high reactivity, and low glass transition temperature. For instance, in embodiments, the urethane acrylate oligomer or the oligomer component containing one or more urethane acrylate oligomers may have a viscosity of less than or about 60,000 cP at 60° C., such as less than or about 59,000 cP, such as less than or about 58,000 cP, such as less than or about 57,000 cP, such as less than or about 56,000 cP, such as less than or about 55,000 cP, such as less than or about 50,000, such as less than or about 45,000 cP, such as less than or about 40,000 cP, such as less than or about 35,000 cP, such as less than or about 30,000 cP, such as less than or about 25,000 cP, such as less than or about 20,000 cP, such as less than or about 15,000 cP, such as less than or about 10,000 cP, such as less than or about 7,500 cP, or any ranges or values therebetween. However, as will be discussed in greater detail below, in embodiments, the one or more reactive monomers may be selected to instead reduce the viscosity of the composition.

Nonetheless, in embodiments, the urethane acrylate oligomer or the oligomer component containing one or more urethane acrylate oligomers may exhibit a glass transition temperature of less than or about 40° C. measured according to ASTM D341 (2023, if utilizing differential scanning calorimetry) or ASTM D4065, D4440, or D5279 (2023, if utilizing dynamic mechanical analysis), such as less than or about 35° C., such as less than or about 30° C., such as less than or about 25° C., such as less than or about 20° C., such as less than or about 15° C., such as less than or about 10° C., such as less than or about 5° C., such as less than or about 0° C., such as less than or about −5° C., such as less than or about −10° C., such as less than or about −15° C., such as less than or about −20° C., such as less than or about −30° C., such as less than or about −35° C., or any ranges or values therebetween.

In embodiments, the urethane acrylate oligomer or the oligomer component containing one or more urethane acrylate oligomers may exhibit tailored tensile strength and Young's Modulus so as to provide excellent toughness without negatively impacting elongation. Thus, in embodiments, the urethane acrylate oligomer or the oligomer component containing one or more urethane acrylate oligomers may exhibit a tensile strength of about 1 mPa, such as greater than or about 2.5 mPa, such as greater than or about 5 mPa, such as greater than or about 7.5 mPa, such as greater than or about 10 mPa, such as greater than or about 15 mPa, such as greater than or about 20 mPa, such as greater than or about 25 mPa, such as greater than or about 30 mPa, such as greater than or about 35 mPa, and such as less than or about 60 mPa, such as less than or about 50 mPa, such as less than or about 45 mPa, such as less than or about 40 mPa, such as less than or about 35 mPa, such as less than or about 35 mPa, such as less than or about 30 mPa, or any ranges or values therebetween.

Moreover, the urethane acrylate oligomer or the oligomer component containing one or more urethane acrylate oligomers may exhibit a Young's Modulus of greater than or about 1 mPa, such as greater than or about 2.5 mPa, such as greater than or about 5 mPa, such as greater than or about 10 mPa, such as greater than or about 15 mPa, such as greater than or about 20 mPa, such as greater than or about 30 mPa, such as greater than or about 40 mPa, such as greater than or about 50 mPa, such as greater than or about 60 mPa, such as greater than or about 70 mPa, such as greater than or about 80 mPa, such as greater than or about 90 mPa, such as greater than or about 100 mPa, such as greater than or about 110 mPa, such as greater than or about 120 mPa, such as greater than or about 130 mPa, such as greater than or about 140 mPa, such as greater than or about 150 mPa, such as greater than or about 160 mPa, such as greater than or about 170 mPa, such as greater than or about 180 mPa, such as greater than or about 190 mPa, such as greater than or about 200 mPa, and such as less than or about 500 mPa, such as less than or about 400 mPa, such as less than or about 300 mPa, such as less than or about 250 mPa, such as less than or about 200 mPa, or any ranges or values therebetween.

Surprisingly, as discussed above, such oligomers also maintain excellent elongation at break. Thus, in embodiments, the urethane acrylate oligomer or the oligomer component containing one or more urethane acrylate oligomers may exhibit an elongation at break of greater than or about 50%, such as greater than or about 55%, such as greater than or about 60%, such as greater than or about 65%, such as greater than or about 70%, such as greater than or about 75%, such as greater than or about 80%, such as greater than or about 85%, such as greater than or about 90%, such as greater than or about 95%, such as greater than or about 100%, such as greater than or abut 105%, such as greater than or about 110%, such as greater than or about 115%, such as greater than or about 120%, such as greater than or about 125%, such as greater than or about 130%, such as greater than or about 140%, such as greater than or about 150%, such as greater than or about 160%, such as greater than or about 170%, such as greater than or about 180%, such as greater than or about 190%, such as less than or about 250%, such as less than or about 225%, such as less than or about 200%, or any ranges or values therebetween.

The curable resin precursor formulation also includes one or more reactive monomers forming a reactive monomer component. By carefully selecting the reactive monomer(s), good solvency may be provided to the oligomer component and overall curable precursor formulation, allowing for excellent viscosity at room temperature to be achieved without compromising the beneficial attributes of the oligomer component. The reactive monomer component may also have a low glass transition temperature, which contributes to the flexibility of the printable resin precursor composition after curing. In embodiments, the reactive monomer component may include an acrylate, an acrylamide, (meth)acrylic acid, a pyrrolidone, a thiol, or combinations thereof.

In embodiments, the monomer component may include at least a first reactive monomer component which may exhibit a first reactive monomer glass transition temperature and a first reactive monomer viscosity and a second reactive monomer component which may exhibit a second reactive monomer glass transition temperature and a second reactive monomer viscosity. In embodiments, the first reactive monomer may have a higher glass transition temperature, a higher viscosity, or both a higher glass transition temperature and a higher viscosity than the second reactive monomer.

The first reactive monomer may thereof exhibit a viscosity of greater than or about 2.5 cP at 25° C., such as greater than or about 3 cP, such as greater than or about 3.5 cP, such as greater than or about 4 cP, such as greater than or about 4.5 cP, such as greater than or about 5 cP, such as greater than or about 5.5 cP, such as greater than or about 6 cP, such as greater than or about 6.5 cP, such as greater than or about 7 cP, such as greater than or about 7.5 cP, such as greater than or about 8 cP, such as greater than or about 8.5 cP, such as greater than or about 9 cP, such as greater than or about 9.5 cP, such as greater than or about 10 cP, or such as less than or about 300 cP, such as less than or about 290 cP, such as less than or about 280 cP, such as less than or about 250 cP, such as less than or about 200 cP, such as less than or about 150 cP, such as less than or about 100 cP, such as less than or about 75 cP, such as less than or about 50 cP, such as less than or about 25 cP, such as less than or about 10 cP, or any ranges or values therebetween.

The first reactive monomer may also exhibit a glass transition temperature of greater than or about 50° C. as measured according to ASTM D341 (2023, if utilizing differential scanning calorimetry) or ASTM D4065, D4440, or D5279 (2023, if utilizing dynamic mechanical analysis), such as greater than or about 52.5° C., such as greater than or about 55° C., such as greater than or about 57.5° C., such as greater than or about 60° C., such as greater than or about 65° C., such as greater than or about 70° C., such as greater than or about 75° C., such as greater than or about 80° C., such as greater than or about 85° C., such as greater than or about 90° C., such as greater than or about 95° C., or such as less than or about 150° C., such as less than or about 125° C., such as less than or about 100° C., or any ranges or values therebetween.

In embodiments, the second reactive monomer may exhibit a viscosity of less than or about 5 cP at 25° C., such as less than or about 4.5 cP, such as less than or about 4 cP, such as less than or about 3.5 cP, such as less than or about 3 cP, such as less than or about 2.5 cP, such a less than or about 2 cP, such as less than or about 1.75 cP, or any ranges or values therebetween.

Furthermore, in embodiments, the second reactive monomer may exhibit a glass transition temperature of less than or about 55° C., such as less than or about 50° C., such as less than or about 45° C., such as less than or about 40° C., such as less than or about 37.5° C., such as less than or about 35° C., such as less than or about 30° C., such as less than or about 25° C., such as less than or about 20° C., such as less than or about 15° C., such as less than or about 10° C., such as less than or about 5° C., such as less than or about 0° C., or any ranges or values therebetween.

However, in embodiments, it may instead be beneficial to provide a monomer component that provides a beneficial average of the glass transition temperature, the viscosity, or both the glass transition temperature and the viscosity of the first reactive monomer component and the second reactive monomer component. Thus, in embodiments, an average of the first glass transition temperature and the second glass transition temperature is less than or about 70° C., such as less than or about 67.5° C., such as less than or about 66° C., such as less than or about 62.5° C., such as less than or about 60° C., such as less than or about 57.5° C., such as less than or about 55° C., such as less than or about 52.5° C., such as less than or about 50° C., such as less than or about 47.5° C., such as less than or about 45° C., such as less than or about 42.5° C., such as less than or about 40° C., or any ranges or values therebetween.

Thus, in embodiments, an average of the first reactive monomer viscosity and the second reactive monomer viscosity is less than or about 50 cP at 25° C., such as less than or about 40 cP, such as less than or about 35 cP, such as less than or about 30 cP, such as less than or about 25 cP, such as less than or about 20 cP, such as less than or about 15 cP, such as less than or about 10 cP, such as less than or about 7.5 cP, such as less than or about 5 cP, or any ranges or values therebetween.

In embodiments, the first reactive monomer, the second reactive monomer, or both may be an acrylate monomer. Examples of suitable mono-functional monomers include, but are not limited to, tetrahydrofurfuryl acrylate (e.g. SR285 from Sartomer®), tetrahydrofurfuryl methacrylate, vinyl caprolactam, isobornyl acrylate (“IBOA”), isobornyl methacrylate, 2-phenoxyethyl acrylate, 2-phenoxyethyl methacrylate, 2-(2-ethoxyethoxy)ethyl acrylate, isooctyl acrylate, isodecyl acrylate, isodecyl methacrylate, lauryl acrylate, lauryl methacrylate, stearyl acrylate, stearyl methacrylate, cyclic trimethylolpropane formal acrylate, 2-[[(butylamino) carbonyl]oxy]ethyl acrylate (e.g., Genomer 1 122 from RAHN USA Corporation or Photomer® 4184 from IGM Resins), 3,3,5-trimethylcyclohexane acrylate, and mono-functional methoxylated PEG (350) acrylate, 2-carboxyethyl acrylate, 2-hydroxyethyl methacrylate, 2-hydroxyethyl acrylate, cyclic trimethylolpropane formal acrylate, dendritic acrylate, dendritic thioether acrylate, hydroxy pivalic acid neopentyl glycol diacrylate, 4-tert-butylcyclohexyl acrylate, combinations thereof, as well as other mono-functional monomers.

Examples of suitable di-functional or higher functional monomers include, but not are limited to, diacrylates or dimethacrylates of diols and polyether diols, such as propoxylated neopentyl glycol diacrylate, 1,6-hexanediol diacrylate, 1,6-hexanediol dimethacrylate, 1,3-butylene glycol diacrylate, 1,3-butylene glycol dimethacrylate, 1,3-1-butanediol diacrylate, 1,4-butanediol diacrylate, 1,4-butanediol dimethacrylate, dicyclopentanyl acrylate (e.g., FA-513A from Hitachi Chemical), dicyclopentanyl methacrylate (e.g., FA-513M from Hitachi Chemical), 3,3,5-trimethyl cyclohexyl acrylate (e.g., SR420 from Sartomer®), alkoxylated aliphatic diacrylate (e.g., SR9209A from Sartomer®), diethylene glycol diacrylate, diethylene glycol dimethacrylate, dipropylene glycol diacrylate (e.g., SR508 from Sartomer®), tetrahydrofurfuryl acrylate (e.g., SR285 from Sartomer®), 1,4-butanediylbis[oxy(2-hydroxy-3,1-propanediyl)]bisacrylate, polyether modified polydimethylsiloxane, tripropylene glycol diacrylate, triethylene glycol dimethacrylate, and alkoxylated hexanediol diacrylates, e.g. SR562, SR563, SR564 from Sartomer®, combinations thereof, trimethylolpropane triacrylate, as well as other di-functional monomers.

In embodiments, suitable acrylate monomers may include isobornyl acrylate, 3,3,5-trimethylcyclohexyl acrylate, (2-[[(butylamino)carbonyl]oxy]ethyl acrylate), or combinations thereof.

The reactive monomer component may also include one or more pyrrolidones, an example of which is N-vinyl-2-pyrrolidone, one or more acrylamides, including N,N-diethyl acrylamide and N-(2-hydroxyethyl)acrylamide, an acrylic or methacrylic acid, thiols including pentaerythritol tetra (3-mercaptopropionate) and ethylene glycol bis(3-mercaptopropionate), and combinations thereof, alone or in combination with one or more acrylates discussed above.

The reactive monomer component may be a multifunctional component. The functionality of the monomer component may be three or less. The functionality of the monomer component may be two or less. In embodiments, the monomer component comprises both mono-functional and di-functional monomers. However, in embodiments, the monomer component may contain one or more monomers having a functionality of greater than 1, such as greater than or about 1.1, such as greater than or about 1.2, such as greater than or about 1.3, such as greater than or about 1.4, such as greater than or about 1.5, such as greater than or about 1.6, such as greater than or about 1.7, such as greater than or about 1.8, such as greater than or about 1.9, such as greater than or about 2, such as greater than or about 3, such as greater than or about 4, such as greater than or about 5, such as greater than or about 10, or such as less than or about 20, such as less than or about 10, such as less than or about 8, such as less than or about 6, such as less than or about 5, such as less than or about 4, such as less than or about 2, such as less than or about 2, or any ranges or values therebetween.

In embodiments, the first reactive monomer, the second reactive monomer, or both the first and second reactive monomer is isobornyl acrylate, 3,3,5-trimethylcyclohexyl acrylate, N-vinyl-2-pyrrolidone, N,N-diethyl acrylamide, (2-[[(butylamino)carbonyl]oxy]ethyl acrylate), acrylic acid, methacrylic acid, 2-carboxyethyl acrylate, 2-hydroxyethyl methacrylate, 2-hydroxyethyl acrylate, N-(2-hydroxyethyl)acrylamide, tetrahydrofurfuryl acrylate, cyclohexyl acrylate, cyclic trimethylolpropane formal acrylate, pentaerythritol tetra (3-mercaptopropionate), ethylene Glycol Bis(3-mercaptopropionate), or a combination thereof.

In embodiments, the first reactive monomer, the second reactive monomer, or both the first and second reactive monomer is isobornyl acrylate, 3,3,5-trimethylcyclohexyl acrylate, N-vinyl-2-pyrrolidone, N,N-diethyl acrylamide, (2-[[(butylamino)carbonyl]oxy]ethyl acrylate), N-(2-hydroxyethyl)acrylamide, or a combination thereof. Moreover, in embodiment, the first reactive monomer is isobornyl acrylate, N,N-diethyl acrylamide, N-(2-hydroxyethyl)acrylamide, or a combination thereof. Additionally or alternatively, the second reactive monomer is 3,3,5-trimethylcyclohexyl acrylate, N-vinyl-2-pyrrolidone, (2-[[(butylamino)carbonyl]oxy]ethyl acrylate), or a combination thereof.

Moreover, in embodiments, monomer or the monomer component containing one or more monomer may be present in the curable precursor formulation or the printable resin precursor composition in an amount of greater than or about 5 wt. %, such as greater than or about 10 wt. %, such as greater than or about 15 wt. %, such as greater than or about 20 wt. %, such as greater than or about 25 wt. %, such as greater than or about 30 wt. %, such as greater than or about 35 wt. %, such as greater than or about 40 wt. %, such as greater than or about 45 wt. %, such as greater than or about 50 wt. %, such as greater than or about 55 wt. %, such as greater than or about 60 wt. %, such as greater than or about 65 wt. %, such as greater than or about 70 wt. %, such as greater than or about 75 wt. %, such as greater than or about 80 wt. %, such as greater than or about 85 wt. %, such as greater than or about 90 wt. %, based on the total weight of the curable precursor formulation or the printable resin precursor composition, or any ranges or values therebetween The amount of the oligomer component in the resin precursor composition may be from about 20 wt. % to about 90 wt. % based on the total weight of the resin precursor composition such as from about 25 wt. % to about 85 wt. %., such as from about 30 wt. % to about 80 wt. %, such as from about 35 wt. % to about 75 wt. %, or from about 40 wt. % to about 70 wt. %, or any ranges or values therebetween or discussed above.

The printable resin precursor composition may also include one or more photoinitiator components. In embodiments, the curing process may include where the photoinitiator component initiates the curing in response to introduced energy, such as incident radiation. The selection of the type of the photoinitiator component in the resin precursor composition is generally dependent on the wavelength or type of energy introduced during the curing employed in curing the resin precursor composition. Typically, the peak absorption wavelengths of the selected photoinitiator vary with the range of wavelength of curing radiation to effectively utilize radiation energy, especially using ultraviolet light as radiation.

Two types of free radical photoinitiators may be used in one or more of the embodiments of compositions herein. The first type of photoinitiator, which is also referred to herein as a bulk cure photoinitiator, is an initiator, which cleaves upon exposure to UV radiation, yielding a free radical immediately, which may initiate a polymerization. Bulk cure photoinitiators may be useful for both surface and through or bulk cure of the dispensed droplets. Exemplary bulk cure photoinitiators may be include, but are not restricted to, benzoin ethers, benzyl ketals, acetyl phenones, alkyl phenones, and phosphine oxides.

The second type of photoinitiator, which is also referred to herein as a surface cure photoinitiator, is a photoinitiator that is activated by UV radiation and forms free radicals by hydrogen abstraction from a second compound, which becomes the actual initiating free radical. Surface cure photoinitiators are often called a co-initiator or polymerization synergist, and may be an amine synergist. Amine synergists are used to diminish oxygen inhibition, and therefore, the surface cure photoinitiator may be useful for fast surface cure. Exemplary surface cure photoinitiators may include, but are not restricted to, benzophenone compounds and thioxanthone compounds. An amine synergist may be an amine with an active hydrogen, and in embodiments, an amine synergist, such as an amine containing acrylate may be combined with a benzophenone photoinitiator in a curable precursor formulation. Namely, in embodiments, such blends may limit oxygen inhibition, contribute to fast cure of a droplet or layer surface so as to fix the dimensions of the droplet or layer surface, increase layer stability through the curing process, or combinations thereof. However, in embodiments, it should be understood that only one photoinitiator may be necessary.

Non-limiting examples of suitable photoinitiators include, but are not limited to, 1-hydroxycyclohexylphenyl ketone, 4-isopropylphenyl-2-hydroxy-2-methyl propan-1-one, 1-[4-(2-hydroxyethoxy)-phenyl]-2-hydroxy-2-methyl-1-propan-1-one, 2,2-dimethyl-2-hydroxy-acetophenone, 2,2-dimethoxy-2-phenylacetophenone, 2-hydroxy-2-methylpropionphenone, diphenyl (2,4,6-trimethylbenzoyl) phosphine oxide, bis(2,6-dimethoxy-benzoyl)-2,4,6 trimethyl phenyl phosphine oxide, 2-methyl-1-1 [4-(methylthio)phenyl]-2-morpholino-propan-i-one, 3,6-bis(2-methyl-2-morpholino-propionyl)-9-n-octylcarbazole, 2-benzyl-2-(dimethylamino)-1-(4-morpholinyl)phenyl)-1-butanone, benzophenone, 2,4,6-trimethylbenzophenone, isopropyl thioxanthone, phenylbis(2,4,6-trimethylbenzoyl)phosphine oxide, 2-hydroxy-2-methyl-1 phenyl-1-propanone. Suitable blends of photoinitiators commercially available include, but are not limited to, those under the designations of Darocur 4265, Irgacure 819, Irgacure 1 173, Irgacure 2022, Irgacure 2100 from Ciba® Specialty Chemicals; and Esacure KT37, Esacure KT55, Esacure KT0046 from Lamberti®). The photoinitiator could be from BASF, such as Irgacure series 184, 2022, 2100, 250, 270, 295, 369, 379, 500, 651, TPO, TPO-L, 754, 784, 819, 907, 1 173, or 4265. The amine synergist can be of secondary or tertiary amino compounds with or without acrylic groups. Examples of these items include diethanolamine, triethanolamine, or acrylated synergistic oligoamines (e.g., Genomer 5142). [0071] In one implementation, the photoinitiator is a free radical-type photoinitiator. In one implementation, the photoinitiator is selected from phenylbis(2,4,6-trimethylbenzoyl)phosphine oxide, 2-hydroxy-2-methyl-1-phenyl-1-propanone, 2,4,6-trimethylbenzoyldiphenyl-phosphine oxide, or combinations thereof. In embodiments, the photoinitiator is selected from a group comprising, consisting of, or consisting essentially of benzoin ethers, benzyl ketals, acetyl phenones, alkyl phenones phosphine oxides, benzophenone compounds, and thioxanthone compounds.

In embodiments, to retard or prevent free radical quenching by diatomic oxygen, which slows or inhibits the free radical curing mechanism, it may be beneficial to select a curing atmosphere or environment that is oxygen limited or free of oxygen. Environments that are oxygen limited or free of oxygen include an inert gas atmosphere, and chemical reagents that are dry, degassed and mostly free of oxygen, such as having 20 vol. % or less oxygen by volume of the atmosphere, such as less than or about 15 vol. %, such as less than or about 10 vol. %, such as less than or about 7.5 vol. %, such as less than or about 5 vol. %, such as less than or about 2.5 vol. %, such as less than or about 1 vol. %, or any ranges or values therebetween. Moreover, in embodiments, the atmosphere may be free of oxygen.

In embodiments, the photoinitiator component or individual photoinitiators may be present in the curable precursor formulation or the printable resin precursor composition in an amount greater than or about 0.1 wt. %, such as greater than or about 0.5 wt. %, such as greater than or about 1 wt. %, such as greater than or about 2 wt. %, such as greater than or about 5 wt. %, such as greater than or about 10 wt. %, such as greater than or about 15 wt. %, such as greater than or about 17 wt. %, based on the total weight of the curable precursor formulation or the printable resin precursor composition, or any ranges or values therebetween. The amount of photoinitiator component in the curable precursor formulation or the printable resin precursor composition may be from about 0.1 wt. % to about 20 wt. % relative to the total weight of the curable precursor formulation or the printable resin precursor composition, such as from about 0.5 wt. % to about 5 wt. %, or such as from about 0.5 wt. % to about 2.5 wt. %, or such as from about 5 wt. % to about 10 wt. %, or such as from about 10 wt. % to about 15 wt. %, or such as from about 15 wt. % to about 20 wt. %, or any ranges or values therebetween.

The resin precursor composition may also include one or more emulsifiers, surfactants, or both emulsifiers and surfactants. The one or more emulsifiers may include an anionic surfactant, a cationic surfactant, a nonionic surfactant, an amphoteric surfactant, or a combination thereof. As used herein, “emulsifier” may refer to any compound or substance that enables the formation of an emulsion. Exemplary emulsifiers may include any surface-active compound or polymer capable of stabilizing emulsions, providing the emulsifier contains at least one anionic, cationic, amphoteric or nonionic surfactant and is used in sufficient quantities to provide the resin precursor composition with a porosity-forming agent-in-liquid polymer emulsion. Typically, such surface-active compounds or polymers stabilize emulsions by preventing coalescence of the dispersed amounts of porosity-forming agent within the emulsion. The surface-active compounds useful as emulsifiers in the present resin precursor composition are anionic, cationic, amphoteric or nonionic surfactant or combination of surfactants. Mixtures of surfactants of different types and/or different surfactants of the same type can be used.

In embodiments, the emulsifier, surfactant, or combination thereof may be incorporated into the curable precursor formulation or the printable resin precursor composition in an amount of greater than or about 0.1 wt. %, such as greater than or about 1 wt. %, such as greater than or about 2 wt. %, such as greater than or about 5 wt. %, such as greater than or about 10 wt. %, such as greater than or about 15 wt. %, such as greater than or about 17 wt. %, based on the total weight of the curable precursor formulation or the printable resin precursor composition, or any ranges or values therebetween. The amount of emulsifier component in the curable precursor formulation or the printable resin precursor composition may be from about 0.1 wt. % to about 20 wt. % relative to the total weight of the curable precursor formulation or the printable resin precursor composition, such as from about 1 wt. % to about 5 wt. %, such as from about 5 wt. % to about 10 wt. %, such as from about 10 wt. % to about 15 wt. %, such as from about 15 wt. % to about 20 wt. %, or any ranges or values therebetween.

The printable resin precursor composition may include inorganic particles, organic particles or both organic particles and inorganic particles. As the additive manufacturing printing process involves layer-by-layer sequential deposition of at least one composition per layer, it may also be appropriate to additionally deposit inorganic or organic particles disposed upon or within a pad layer to obtain a certain pad property and/or to perform a certain function. The inorganic or organic particles may be in the 50 nanometer (nm) to 100 micrometer (pm) range in size and may be added to the precursor materials prior to being dispensed by the printer 306, discussed in greater detail below, or added to an uncured printed layer in a ratio of between 1 and 50 weight percent (wt. %). The inorganic or organic particles may be added to during the advanced polishing pad formation process to improve the ultimate tensile strength, improve yield strength, improve the stability of the storage modulus over a temperature range, improve heat transfer, adjust a surfaces zeta potential, and adjust a surface's surface energy.

The particle type, chemical composition, or size, and the added particles may vary by application or targeted effect that is to be achieved. The inorganic or organic particles may be in the 25 nanometer (nm) to 100 micrometer (pm) range in size and may be added to the precursor materials prior to being dispensed by the droplet ejecting printer or added to an uncured printable resin precursor or curable precursor formulation in a ratio of between 1 and about 50 weight percent (wt. %). In some implementations, the particles may include intermetallics, ceramics, metals, polymers and/or metal oxides, such as ceria, alumina, silica, zirconia, zinc oxides, zinc sulfides, nitrides, carbides, or a combination thereof. In one example, the inorganic or organic particles disposed upon or within a pad may include particles of high performance polymers, such PEEK, PEK, PPS, and other similar materials to improve the thermal conductivity and/or other mechanical properties of the advanced polishing pad.

The particle component in the resin precursor composition may be incorporated into the curable precursor formulation or the printable resin precursor composition in an amount of greater than or about 0.1 wt. %, such as greater than or about 1 wt. %, such as greater than or about 2 wt. %, such as greater than or about 5 wt. %, such as greater than or about 10 wt. %, such as greater than or about 15 wt. %, such as greater than or about 17 wt. % based on the total weight of the curable precursor formulation or the printable resin precursor composition, or any ranges or values therebetween. The amount of particle component in the curable precursor formulation or the printable resin precursor composition may be from about 0.1 wt. % to about 20 wt. % relative to the total weight of the curable precursor formulation or the printable resin precursor composition, or such as from about 1 wt. % to about 5 wt. %, such as from about 5 wt. % to about 10 wt. %, such as from about 10 wt. % to about 15 wt. %, or such as from about 15 wt. % to about 20 wt. %, or any ranges or values therebetween.

The curable precursor formulation or the printable resin precursor composition may also include one or more porosity-forming agents. In embodiments, porosity-forming agent may include glycols, glycol-ethers, amines, or combinations thereof. In embodiments, the porosity-forming agent may include ethylene glycol, butanediol, dimer diol, propylene glycol-(1,2) and propylene glycol-(1,3), octane-1,8-diol, neopentyl glycol, cyclohexane dimethanol (1,4-bis-hydroxymethylcyclohexane), 2-methyl-1,3-propane diol, glycerin, trimethylolpropane, hexanediol-(1,6), hexanetriol-(1,2,6) butane triol-(1,2,4), trimethylolethane, pentaerythritol, quinitol, mannitol and sorbitol, methylglycoside, diethylene glycol, triethylene glycol, tetraethylene glycol, polyethylene glycols, dibutylene glycol, polybutylene glycols, ethylene glycol, ethylene glycol monobutyl ether (EGMBE), diethylene glycol monoethyl ether, ethanolamine, diethanolamine (DEA), triethanolamine (TEA) or combinations thereof. The amount of porosity forming agent in the curable precursor formulation or the printable resin precursor composition from about 0.1 wt. % to about 20 wt. % relative to the total weight of the curable precursor formulation or the printable resin precursor composition, such as from about 1 wt. % to about 5 wt. %, such as from about 5 wt. % to about 10 wt. %, such as from about 10 wt. % to about 15 wt. %, or such as from about 15 wt. % to about 20 wt. %, or any ranges or values therebetween.

In embodiments, the curable precursor formulation or the printable resin precursor may include an additional crosslinking component. Suitable crosslinking agents may include one or more multi-function acrylates. In embodiments, crosslinking agents may include trimethylolpropane triacrylate, 1,6-Hexanediol diacrylate, bisphenol A glycerolate diacrylate, tricyclodecanedimethanol diacrylate, dendritic acrylate, dendritic thioether acrylate, hydroxy pivalic acid neopentyl glycol diacrylate, 4-tert-butylcyclohexyl acrylate, combinations thereof, or other crosslinking agents as known in the art. The crosslinking agent may be present in the curable precursor formulation or the printable resin precursor composition in an amount of greater than or about 0.1 wt. %, such as greater than or about 1 wt. %, such as greater than or about 2 wt. %, such as greater than or about 5 wt. %, such as greater than or about 10 wt. %, such as greater than or about 15 wt. %, or such as in an amount from about 0.1 wt. % to about 20 wt. % relative to the total weight of the curable precursor formulation or the printable resin precursor composition, such as from about 1 wt. % to about 5 wt. % such as from about 5 wt. % to about 10 wt. %, such as from about 10 wt. % to about 15 wt. % or such as from about 15 wt. % to about 20 wt. %, or any ranges or values therebetween.

The curable precursor formulation or the printable resin precursor composition may further include or more additional additives. Additional additives include, but are not limited to stabilizers, surfactants, leveling additives, pH adjusters, sequestering agents, oxygen scavengers, polymer spheres and colorants.

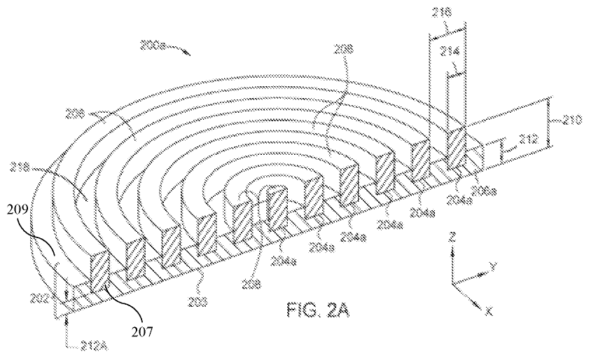

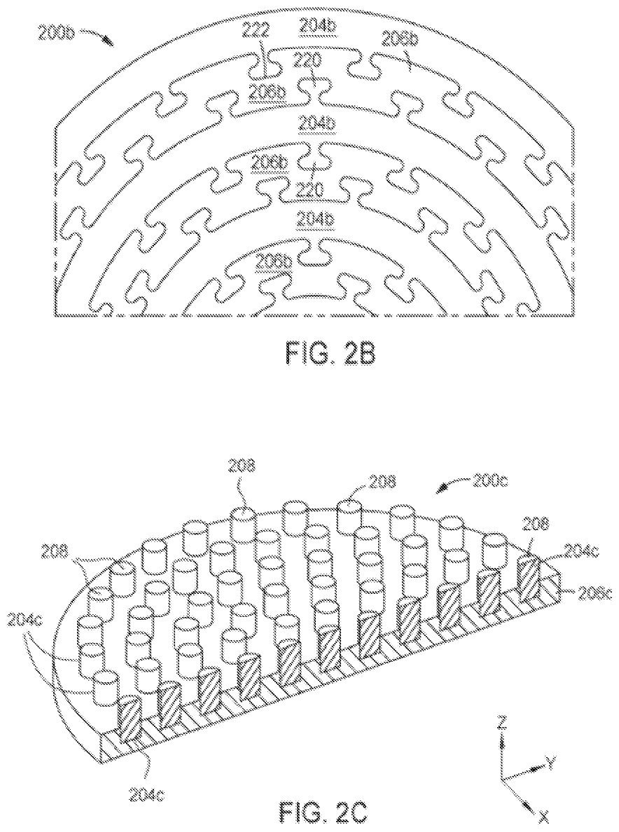

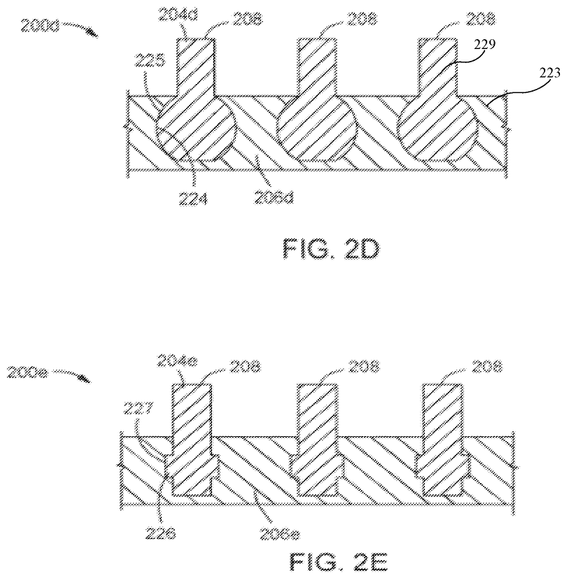

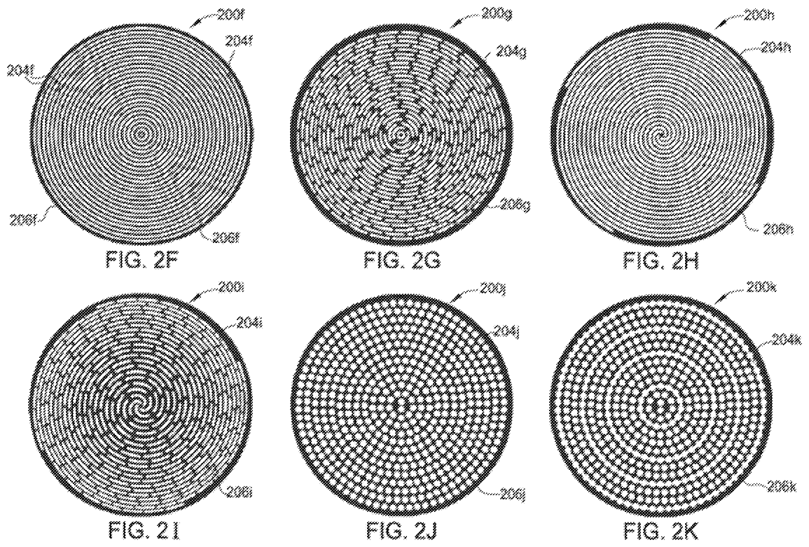

Nonetheless, regardless of the printable resin precursor composition or curable precursor formulation utilized, exemplary polishing pads that may be formed from one or more embodiments of the formulations and/or compositions discussed herein may be illustrated in FIGS. 2A-2k. The polishing pads illustrated in FIGS. 2A-2K may be used, for example, in the polishing system 100 depicted in FIG. 1. Unless otherwise specified, the terms first polishing element(s) 204 and the second polishing element(s) 206 broadly describe portions, regions and/or features within the polishing body of the polishing article 200. In embodiments, the polishing article 200 may contain pores or a material that will form a void in the surface of the pad once it is exposed to a slurry, such as during a polishing operation. Examples of polishing pads, such as embodiments illustrated in FIGS. 2A-2K, are not intended to limit the scope of the disclosure provided herein. Instead, it should be understood that other polishing pad orientations may be provided with one or more formulations discussed herein and/or via one or more of additive manufacturing processes described herein.

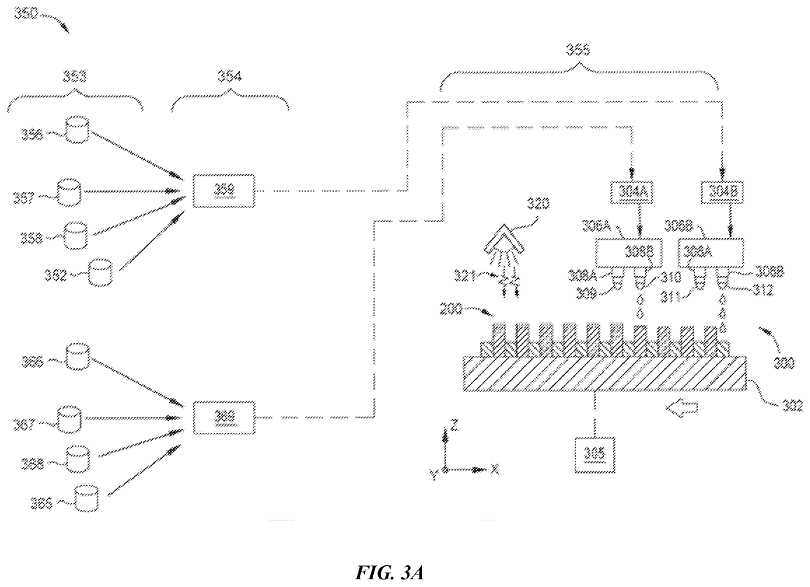

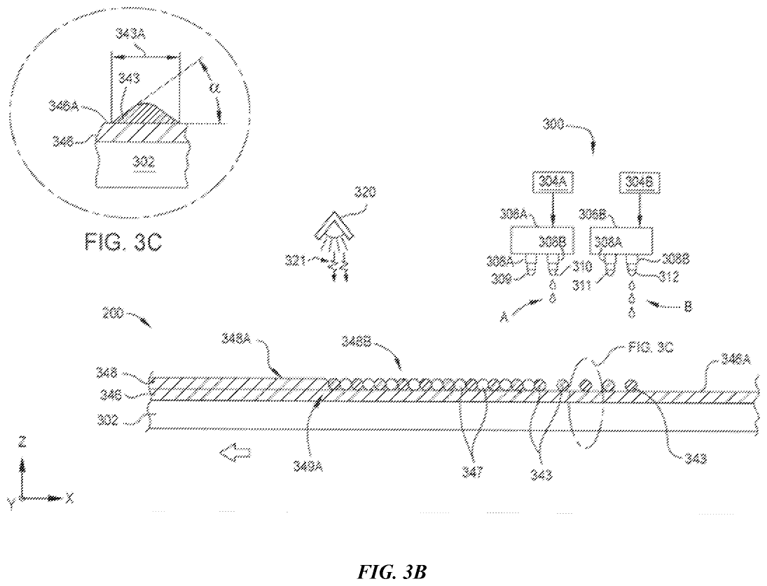

In embodiments, polishing pads may be formed by a layer-by-layer automated sequential deposition of at least one resin precursor composition followed by at least one curing process. In such embodiments, each layer may represent at least one polymer composition, and/or regions of different compositions. The curable precursor formulations(s) may include any one or more of the components discussed above. To form one or more solidified polymeric layers, a curing process, or sequential curing processes may be used, such as exposure of one or more compositions to UV radiation and/or thermal energy. In this fashion, an entire polishing pad may be formed from one or more polymeric layers by an additive manufacturing process, as will be discussed in greater detail in FIGS. 3A-3C. In embodiments, a thickness of each cured layer, or of all of the cured layers, may be from about 0.1 microns to about 1 mm, such as from about 5 microns to about 100 microns, or, in embodiments, from about 25 microns to about 30 microns.

In embodiments, polishing pads according to the present disclosure may have differing material properties, such as porosity as an example only, across the pad body 202. In embodiments, the one or more material properties may vary across the surface or depth of the polishing pad, such as at least one compositional gradient moving from one polishing element 204 to another polishing element 204. In embodiments, a material property, such as porosity, across the polishing article 200 may be symmetric or non-symmetric, uniform or non-uniform, as desired to achieve target polishing pad properties, which may include static mechanical properties, dynamic mechanical properties and wear properties. In embodiments, pores may be formed near the interface of each adjacent deposited layer, which will be discussed in greater detail below. The patterns of either of the polishing elements 204, 206 across the pad body 202 may be radial, concentric, rectangular, spiral, fractal or random to achieve target properties including porosity, across the polishing pad. Advantageously, the 3D printing process enables specific placement of material compositions with targeted properties in specific areas of the pad, or over larger areas of the pad, so the properties can be combined and represent a greater average of properties or a “composite” of the properties. However, it should be understood that, in embodiments, the precursor formulation(s) may be deposited in a generally uniform configuration across a layer or through a depth of the polishing article.

FIG. 2A is a schematic perspective sectional view of a polishing article 200a according to embodiments of the present disclosure. One or more first polishing elements 204a may be formed in alternating concentric rings that are coupled to one or more second polishing elements 206a. In embodiments, first polishing elements 204a and second polishing elements 206a may form a pad body 202 that is circular. However, it should be understood that polishing pads as discussed herein may have other shapes, such as square, oval, quadrilateral, hexagonal, as well as other shapes as known in the art. At least one of the one or more first polishing elements 204a and the one or more second polishing elements 206a may be formed utilizing additive manufacturing as will be discussed in greater detail in regard to FIGS. 3A-3C.

Nonetheless, in embodiments a height 210 of the first polishing element(s) 204a from a support surface 203 to upper surface 208 of the respective element 204a is greater than a height 212 of the second polishing element(s) 206a (from the support surface 203 to a top surface 209 of the respective element 206a). In such an embodiment, the upper surface(s) 208 of the first polishing element(s) 204a protrude above an upper surface 209 of the second polishing element(s) 206a. In embodiments, the first polishing element 204a is disposed over a portion 212A of the second polishing element(s) 206a (e.g., a base 207 of first polishing element(s) 204a are positioned above support surface 203). In such an embodiment, the height 210 may extend from the base 207 to the upper surface 208, but it should be understood that, in embodiments, the upper surface 208 still extends above upper surface 209. Grooves 218 or channels may be formed between the first polishing element(s) 204a, and at least include a portion of the second polishing element(s) 206a. During polishing, the upper surface(s) 208 of the first polishing elements 204a may form a polishing surface that contacts the substrate, while the grooves 218 retain and channel the polishing fluid, also referred to as a slurry. In embodiments, the first polishing element(s) 204a have a height 210 is greater than a height 212 of the second polishing element(s) 206a in a direction generally perpendicular to the polishing surface, or upper surface(s) 208, of the pad body 202 (i.e., Z-direction in FIG. 2A), such that upper surface 208 is disposed above upper surface 209. In such a manner, the channels or grooves 218 are formed on the top surface of the pad body 202.

In embodiments, a width 214 of the first polishing elements 204a may be between about 250 microns and about 5 millimeters, such as greater than or about 300 microns, such as greater than or about 350 microns, such as greater than or about 400 microns, such as greater than or about 450 microns, such as greater than or about 500 microns, such as greater than or about 600 microns, such as greater than or about 700 microns, such as greater than or about 800 microns, such as greater than or about 900 microns, such as greater than or about 1 millimeter (mm), such as greater than or about 1.5 mm, such as greater than or about 2 mm, such as greater than or about 2.5 mm, such as greater than or about 3 mm, such as greater than or about 3.5 mm, such as greater than or about 4 mm, such as greater than or about 4.5 mm, or such as less than or about 4.9 mm, such as less than or about 4.8 mm, such as less than or about 4.7 mm, such as less than or about 4.6 mm, such as less than or about 4.5 mm, such as less than or about 4.25 mm, such as less than or about 4 mm, such as less than or about 3.75 mm, such as less than or about 3.5 mm, such as less than or about 3.25 mm, such as less than or about 3 mm, such as less than or about 2.75 mm, such as less than or about 2.5 mm, such as less than or about 2.25 mm, such as less than or about 2 mm, such as less than or about 1.75 mm, such as less than or about 1.5 mm, such as less than or about 1.25 mm, such as less than or about 1 mm, such as less than or about 750 microns, or any ranges or values therebetween. In embodiments, each first polishing element 204a may have a width within a range between about 250 microns and about 2 millimeters.

In embodiments, the pitch 216 between adjacent first polishing element(s) 204a may be between about 500 microns and about 5 millimeters, such as greater than or about 600 microns, such as greater than or about 700 microns, such as greater than or about 800 microns, such as greater than or about 900 microns, such as greater than or about 1 millimeter (mm), such as greater than or about 1.5 mm, such as greater than or about 2 mm, such as greater than or about 2.5 mm, such as greater than or about 3 mm, such as greater than or about 3.5 mm, such as greater than or about 4 mm, such as greater than or about 4.5 mm, or such as less than or about 4.9 mm, such as less than or about 4.8 mm, such as less than or about 4.7 mm, such as less than or about 4.6 mm, such as less than or about 4.5 mm, such as less than or about 4.25 mm, such as less than or about 4 mm, such as less than or about 3.75 mm, such as less than or about 3.5 mm, such as less than or about 3.25 mm, such as less than or about 3 mm, such as less than or about 2.75 mm, such as less than or about 2.5 mm, such as less than or about 2.25 mm, such as less than or about 2 mm, such as less than or about 1.75 mm, such as less than or about 1.5 mm, such as less than or about 1.25 mm, such as less than or about 1 mm, such as less than or about 750 microns, or any ranges or values therebetween. However, it should be understood that, in embodiments, the width 214 and/or the pitch 216 may vary across a radius of the polishing article 200 to define zones of varied hardness, porosity, or both hardness and porosity, as well as other properties as known in the art.

FIG. 2B illustrates a schematic partial top view of a polishing article 200b according to embodiments of the present disclosure. The polishing article 200b may include any one or more of the features discussed in regard to FIG. 2A and may include interlocking first polishing elements 204b and second polishing elements 206b. In embodiments, at least one of the interlocking first polishing elements 204b and the second polishing elements 206b may be formed according to methods and processes discussed herein. The interlocking first polishing elements 204b and the second polishing elements 206b may form two or more concentric rings. The interlocking first polishing elements 204b may include protruding vertical ridges 220 and the second polishing elements 206b may include vertical recesses 222 for receiving the vertical ridges 220. Alternatively, the second polishing elements 206b may include protruding ridges while the interlocking first polishing elements 204b include recesses. By having the second polishing elements 206b interlock with the first polishing elements 204b, the polishing article 200b may exhibit further improved mechanical strength, such as improved strength when exposed to applied shear forces which may be generated during the CMP process and/or material handling. Moreover, interlocking first and second polishing elements may also improve the strength of the polishing pad, contributing to increased physical integrity of the polishing pads. In embodiments, the interlocking elements may be physically interlocked or may be interlocked via one or more chemical forces.

FIG. 2C is a schematic perspective sectional view of a polishing article 200c according to embodiments of the present disclosure. The polishing article 200c may include a plurality of first polishing elements 204c extending from a base material layer, such as the second polishing element 206c. At least one of the plurality of first polishing elements 204c and the second polishing element 206c may be formed according to embodiments discussed above, and the polishing article 200c may include one or more of the features discussed in regards to FIGS. 2A and 2B. Upper surfaces 208 of the first polishing elements 204c may form a polishing surface for contacting the substrate during polishing. In embodiments, the first polishing elements 204c and the second polishing elements 206c may have different material and structural properties. For example, one or more first polishing elements 204c may be formed from a formulation discussed herein, while the second polishing elements 206c may be formed from the same formulation or a different formulation as will be discussed in greater detail below, or may be formed from other materials as known in the art. The polishing article 200c may be formed by 3D printing, similar to the polishing article 200.

In embodiments, the first polishing elements 204c may have a similar size, such as being substantially the same size, or may vary in size to create different mechanical properties, such as porosity or elongation, across the polishing article 200c. One or more first polishing elements 204c may be uniformly distributed across the polishing article 200c, or may be arranged in a non-uniform pattern, such as any one or more patterns discussed above, to achieve target properties in the polishing article 200c.

In FIG. 2C, the first polishing elements 204c are shown to be circular columns extending from the second polishing elements 206c. Alternatively, one or more first polishing elements 204c may be of any suitable cross-sectional shape, for example columns with toroidal, partial toroidal (e.g., arc), oval, square, rectangular, triangular, polygonal, or other irregular section shapes, or combinations thereof. In embodiments, a first plurality of first polishing elements 204c may be of different cross-sectional shapes than a second plurality of first polishing elements 204c to tune hardness, mechanical strength, or other targeted properties of the polishing article 200c. Furthermore, it should be clear that, in embodiments, any of the first polishing elements, or a portion thereof 200, 200a, 200b, 200c, may have different shapes, sizes, heights, thicknesses, or the like, in order to tune one or more desired polishing pad properties.

FIG. 2D illustrates a schematic partial side cross-sectional view of a pad body 202 of a polishing article 200d according to embodiments of the present disclosure. The polishing article 200d may include one or more features of polishing article 200a, 200b, and/or 200c of FIGS. 2A-2C alone or in combination with interlocking first polishing elements 204d and second polishing elements 206d. As discussed above, at least one of the plurality of interlocking first polishing elements 204d and the second polishing element 206d may be formed from one or more of the formulations discussed herein, or may be formed from other materials as known in the art. The interlocking first polishing elements 204d and the second polishing elements 206d may include one or more concentric rings and/or discrete elements that form part of the pad body 202, which are illustrated, for example, in FIGS. 2A, 2B and 2C. In embodiments, the interlocking first polishing elements 204d may include protruding sidewalls 224 while the second polishing elements 206d may include hollow regions 225 having a shape and size to receive the protruding sidewalls 224 of the interlocking first polishing elements 204d. Alternatively, the second polishing elements 206d may include protruding sidewalls while the interlocking first polishing elements 204d include regions that are configured to receive the protruding sidewalls. In embodiments, the second polishing elements 206d and/or first polishing elements 204d may contain a collar region 223 disposed between the protrusion (such as 224 if the first polishing element contains the protrusion), and the extending stem portion 229. As discussed, in embodiments, by interlocking the second polishing elements 206d with the interlocking first polishing elements 204d, the polishing article 200d may exhibit even further increased tensile, compressive and/or shear strength, when desired.

In embodiments, the boundaries between the interlocking first polishing elements 204d and second polishing elements 206d include a cohesive transition from at least one composition of material to another, such as a transition or compositional gradient from a first formulation used to form the interlocking first polishing element 204d to a second formulation used to form the second polishing element 206d. The cohesiveness of the materials is a result of the additive manufacturing process described herein, which enables micron scale control and intimate mixing of the two or more chemical compositions in a layer-by-layer additively formed structure.

FIG. 2E illustrates a schematic partial sectional view of a polishing article 200e according to embodiments of the present disclosure. The polishing article 200e may contain any one or more features of polishing article 200d of FIG. 2D but may exhibit different interlocking features. The polishing article 200e may include one or more first polishing elements 204e and second polishing elements 206e having a plurality of concentric rings and/or discrete elements. At least one of the first polishing elements 204e and the second polishing elements 206e may be formed utilizing one or more formulations discussed herein. In embodiments, the first polishing elements 204e may include horizontal ridges 226 while the second polishing elements 206e may include horizontal recesses 227 to receive the horizontal ridges 226 of the first polishing elements 204e. Alternatively, the second polishing elements 206e may include horizontal ridges while the first polishing elements 204e include horizontal recesses. In embodiments, vertical interlocking features, such as the interlocking features of FIG. 2B and horizontal interlocking features, such as the interlocking features of FIGS. 2D and 2E, may be combined to form a polishing pad.

FIGS. 2F-2K illustrate schematic plan views of various polishing article designs according to embodiments of the present disclosure. FIGS. 2F-2K include pixel charts having white regions (regions in white pixels) that represent the first polishing elements 204f-204k, respectively, which may illustrate features for contacting and polishing a substrate, and black regions (regions in black pixels) that represent the second polishing element(s) 206f-206k. As similarly discussed herein, the white regions generally protrude over the black regions so that channels are formed in the black regions between the white regions. In an example, the pixels in a pixel chart are arranged in a rectangular array type pattern (e.g., X and Y oriented array) that are used to define the position of the various materials within a layer, or a portion of layer, of an advanced polishing pad. In another example, the pixels in a pixel chart are arranged in a hexagonal close pack array type of pattern (e.g., one pixel surrounded by six nearest neighbors) that are used to define the position of the various materials within a layer, or a portion of layer of a polishing pad. Polishing slurry may flow through and be retained in the channels during polishing. The polishing articles shown in FIGS. 2F-2K may be formed by depositing a plurality of layers of materials using an additive manufacturing process. Each of the plurality of layers may include two or more materials to form the first polishing elements 204f-204k and the second polishing element(s) 206f-206k. In embodiments, the first polishing element(s) 204f-204k may be thicker than the second polishing element(s) 206f-206k in a direction normal to a plane that is parallel to the plurality of layers of materials so that grooves and/or channels are formed on a top surface of the polishing pad. However, as discussed above, in embodiments, only one material, e.g., one curable precursor formulation may be utilized when forming a polishing article according to one or more of the illustrated pixel charts or may be applied in a generally even layer or depth.

Regardless of the form of the polishing pad, in embodiments, the polishing pad described herein may be formed from at least one resin precursor composition as will be discussed in greater detail below, and which may contain at least one curable precursor formulation. The curable precursor formulation may be a curable precursor formulation as discussed above or may include one or more additional precursor formulations suited for use in additive manufacturing.

For instance, while other formation methods may be utilized, in embodiments, one or more of the polishing articles 110, 200, 200a, 200b, 200c, 200d, as well as other shapes and designs, may be formed utilizing additive manufacturing. FIG. 3A is a schematic sectional view of an additive manufacturing system 350 that can be used to form a polishing pad using an additive manufacturing process according to one or more implementations of the present disclosure. An additive manufacturing process may include, but is not limited to a process, such as a polyjet deposition process, inkjet printing process, fused deposition modeling process, binder jetting process, powder bed fusion process, selective laser sintering process, stereolithographic process, vat photopolymerization process, digital light processing, sheet lamination process, directed energy deposition process, or other similar 3D deposition process.

The additive manufacturing system 350 may include a precursor delivery section 353, a precursor formulation section 354 and a deposition section 355. The precursor formulation section 354 includes a section of the additive manufacturing system 350 where the curable precursor formulation components positioned in the precursor delivery section 353 are mixed to form one or more curable precursor formulation and/or printable resin precursor compositions. The deposition section 355 will generally include an additive manufacturing device, also referred to herein as a printing station 300, that is used to deposit one or more precursor compositions or formulations on layers disposed over a support 302. The polishing article 200 may be printed on the support 302 within the printing station 300. Typically, the polishing article 200 is formed layer-by-layer using one or more droplet ejecting printers 306, such as printer 306A and printer 306B illustrated in FIG. 3A, from a CAD (computer-aided design) program. The printers 306A, 306B and the support 302 may move relative to each other during the printing process.

The droplet ejecting printer 306 may include one or more print heads 308 (e.g., print heads 308A, 308B) having one or more nozzles (e.g., nozzles 309-312) for dispensing liquid precursors. In embodiments, such as shown in FIG. 3A, the printer 306A includes print head 308A that has a nozzle 309 and a second print head 308B having a second nozzle 310. The nozzle 309 may be configured to dispense a first curable precursor formulation to form a first polymer material, such as a porous or non-porous polymer, while the nozzle 310 may be used to dispense a second curable precursor formulation to form a second polymer material, such as a non-porous polymer, or a porous polymer. The curable precursor formulation may be considered to be in liquid form prior to curing and may therefore be referred to as liquid pre-polymer compositions which may be dispensed at selected locations or regions to form a porous polishing pad that has targeted properties. These selected locations collectively form the target printing pattern that can be stored as a CAD-compatible file that is then read by an electronic controller 305, which controls the delivery of the droplets from the nozzles of the droplet ejecting printer 306. It should be understood that, in embodiments, one or both of the first and second curable precursor formulations may be formed according to the formulations and compositions discussed above or may include a formulation or composition discussed herein in combination with a further composition or formulation.

The electronic controller 305 is generally used to facilitate the control and automation of the components within the additive manufacturing system 350, including the printing station 300. The electronic controller 305 can be, for example, a computer, a programmable logic controller, or an embedded controller. The electronic controller 305 typically includes a central processing unit (CPU) (not shown), memory (not shown), and support circuits for inputs and outputs (I/O) (not shown). The CPU may be one of any form of computer processors that are used in industrial settings for controlling various system functions, substrate movement, chamber processes, and control support hardware (e.g., sensors, motors, heaters, etc.), and monitor the processes performed in the system. The memory is connected to the CPU, and may be one or more of a readily available non-volatile memory, such as random access memory (RAM), flash memory, read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the electronic controller 305 determines which tasks are performable by the components in the additive manufacturing system 350. The program may be software readable by the electronic controller 305 that includes code to perform tasks relating to monitoring, execution and control of the delivery and positioning of droplets delivered from the printer 306, and the movement, support, and/or positioning of the components within the printing station 300 along with the various process tasks and various sequences being performed in the electronic controller 305.

After 3D printing, the polishing article 200 may be solidified or partially solidified by use of a curing device 320 that is disposed within the deposition section 355 of the additive manufacturing system 350. However, in embodiments, curing may be performed elsewhere in station 300 or outside of station 300. The curing process performed by the curing device 320 may be performed by heating the printed polishing pad to a curing temperature or exposing the pad to one or more forms of electromagnetic radiation or electron beam curing. In one example, the curing process may be performed by exposing the printed polishing pad to radiation 321 generated by an electromagnetic radiation source, such as a visible light source, an ultraviolet light source, x-ray source, or other type of electromagnetic wave source that is disposed within the curing device 320.

In embodiments, one or more of the first polishing elements 204 and/or one or more of the second polishing element(s) 206 may be formed from a mixture of two or more curable precursor formulation. In one example, a first curable precursor formulation may be dispensed in the form of droplets by a first print head, such as the print head 308A, and the second curable precursor formulation may be dispensed in the form of droplets by a second print head, such as the print head 308B of the printer 306A. To form first polishing elements 204 with a mixture of the droplets delivered from multiple print heads typically includes the alignment of the pixels corresponding to the first polishing elements 204 on predetermined pixels within a deposition map found in the electronic controller 305. The print head 308A may then align with the pixels corresponding to where the first polishing elements 204 are to be formed and then dispense droplets on the predetermined pixels. Thus, in embodiments, the polishing pad may be formed from a first printable resin precursor composition that includes one or more curable precursor formulations, formed by depositing droplets of a first curable precursor formulation and a second curable precursor formulation formed by depositing droplets of a second curable precursor formulation.

FIG. 3B shows a schematic cross-sectional view of a portion of an exemplary printing station 300 and the polishing article 200 during the pad manufacturing process. The printing station 300, as shown in FIG. 3B, includes two printers 306A and 306B that are used to sequentially form a portion of the polishing article 200. The portion of the polishing article 200 shown in FIG. 3B may, for example, include part of either the first polishing element 204 or the second polishing elements 206 in the finally formed polishing article 200. During processing, the printers 306A and 306B are configured to deliver droplets “A” or “B,” respectively, which may contain the same curable precursor formulation or different curable precursor formulations, to a first surface of the support 302 and then successively to a surface of the growing polishing article that is disposed on the support 302 in a layer-by-layer process.

As shown in FIG. 3B, a second layer 348 may be deposited over a first layer 346 which has been formed on the support 302. In embodiments, the second layer 348 is formed over the first layer 346, which has been processed by the curing device 320 that is disposed downstream from the printers 306A and 306B in the manufacturing process. In embodiments, portions of the second layer 348 may be simultaneously processed by the curing device 320 while one or more of the printers 306A and 306B are depositing droplets “A” and/or “B” onto the surface 346A of the previously formed first layer 346. In this case, the layer that is currently being formed may include a processed portion 348A and an unprocessed portion 348B that are disposed on either side of a curing zone 349A. The unprocessed portion 348B generally includes an array of dispensed droplets, such as dispensed droplets 343 and 347, which are deposited on the surface 346A of the previously formed first layer 346 by use of the printers 306B and 306A, respectively.

FIG. 3C illustrates a close up cross-sectional view of an exemplary dispensed droplet 343 that is disposed on a surface 346A of a previously formed first layer 346. Based on the properties of the materials within the dispensed droplet 343, and due to surface energy of the surface 346A the dispensed droplet may spread across the surface in an amount that is larger than the size of the original dispensed droplet (e.g., droplets “A” or “B”), due to surface tension. The amount of spread of the dispensed droplet will vary as a function of time from the instant that the droplet is deposited on the surface 346A. However, after a very short period of time (e.g., <1 second) the spread of the droplet will reach an equilibrium size, and have an equilibrium contact angle α. The spread of the dispensed droplet across the surface affects the resolution of the placement of the droplets on the surface of the growing polishing article, and thus the resolution of the features and material compositions found within various regions of the final polishing article.

In embodiments, it may be useful to expose one or both of the droplets “A” and “B” to an energy source, such as any one or more of the above discussed energy sources, after they have been in contact with the surface of the substrate for a period of time to cure, or “fix,” each droplet at a targeted size before the droplet has a chance to spread to its uncured equilibrium size on the surface of the substrate. In this case, the energy supplied to the dispensed droplet and surface on which the droplet is placed by the curing device 320 and the droplet material composition are adjusted to control the resolution of each of the dispensed droplets. Therefore, one optional parameter to control or tune during a 3D printing process is the control of the dispensed droplet surface tension relative to the surface on which the droplet is disposed.

In embodiments, it is useful to add one or more curing enhancement components (e.g., photoinitiators, one or more of which have been discussed above) to the curable precursor formulation to control the kinetics of the curing process, prevent oxygen inhibition, and/or control the contact angle of the droplet on the surface on which the droplet is deposited. One will note that the curing enhancement components will generally include materials that are able to adjust: 1) the amount of bulk curing that occurs in the material in the dispensed droplet during the initial exposure to a targeted amount of electromagnetic radiation, 2) the amount of surface curing that occurs in the material in the dispensed droplet during the initial exposure to a targeted amount of electromagnetic radiation, and 3) the amount of surface property modification (e.g., additives) to the surface cured region of the dispensed droplet. The amount of surface property modification to the surface cured region of the dispensed droplet generally includes the adjustment of the surface energy of the cured or partially cured polymer found at the surface of the dispensed and at least partially cured droplet.

It has been found that it is useful to partially cure each dispensed droplet to “fix” its surface properties and dimensional size during the printing process. The ability to “fix” the droplet at a targeted size can be accomplished by adding a targeted amount of at least one curing enhancement components to the droplet's material composition and delivering a sufficient amount of electromagnetic energy from the curing device 320 during the additive manufacturing process. In some implementations, it is useful to use a curing device 320 that is able to deliver between about 1 milli-joule per centimeter squared (mJ/cm²) and 100 mJ/cm², such as about 10-20 mJ/cm², of ultraviolet (UV) light to the droplet during the additive layer formation process. The UV radiation may be provided by any UV source, such as mercury microwave arc lamps (e.g., H bulb, H⁺bulb, D bulb, Q bulb, and V bulb type lamps), pulsed xenon flash lamps, high-efficiency UV light emitting diode arrays, and UV lasers. The UV radiation may have a wavelength between about 170 nm and about 500 nm.

In embodiments, the droplet size 343A of dispensed droplets “A”, “B” may be from about 10 to about 200 microns, such as from about 20 microns to about 175 microns, such as from about 30 microns to about 150 microns, such as about 35 microns to about 125 microns, such as about 40 microns to about 100 microns, such as about 50 to about 70 microns, or any ranges or values therebetween. Depending on the surface energy (dynes) of the substrate or polymer layer that the droplet is dispensed over and upon, the uncured droplet may spread on and across the surface to a fixed droplet size 343A of between about 10 and about 500 microns, such as between about 50 and about 200 microns. In an example, the height of such a droplet may be from about 5 to about 100 microns, depending on such factors as surface energy, wetting, and/or resin precursor composition, which may include other additives, such as flow agents, thickening agents, and surfactants. One source for the additives is BYK-Gardner GmbH of Geretsried, Germany.

In embodiments, it may be useful to select a photoinitiator, an amount of the photoinitiator in the droplet composition, and/or the amount of energy supplied by the curing device 320 to allow the dispensed droplet to be “fixed” at the desired size in less than about 1 second, such as less than about 0.5 seconds after the dispensed droplet has come in contact with the surface on which it is to be fixed. The actual time it takes to partially cure the dispensed droplet, due to the exposure to delivered curing energy, may be longer or shorter than the time that the droplet resides on the surface before it is exposed to the delivered radiation, since the curing time of the dispensed droplet will depend on the amount of radiant energy and wavelength of the energy provided from the curing device 320. In one example, an exposure time used to partially cure a 120 micrometer (m) dispensed droplet is about 0.4 microseconds (s) for a radiant exposure level of about 10-15 mJ/cm² of UV radiation. As an example of a method to “fix” the droplet in this short timeframe the dispense nozzle of the droplet ejecting printer 306 may be positioned a short distance from the surface of the polishing pad, such as between 0.1 and 10 millimeters (mm), or even 0.5 and 1 mm, while the surface 346A of the polishing pad are exposed to the radiation 321 delivered from the curing device 320. It has also been found that by controlling droplet composition, the amount of cure of the previously formed layer (e.g., surface energy of the previously formed layer), the amount of energy from the curing device 320 and the amount of the photoinitiator in the droplet composition, the contact angle α of the droplet can be controlled to obtain the desired droplet size, and thus the resolution of the printing process. In one example, the underlying layer cure may be a cure of about 70% acrylate conversion, which will be discussed in greater detail below.

A droplet that has been fixed, or at least partially cured, is also referred to herein as a cured droplet. In embodiments, the fixed droplet size 343A is between about 10 and about 200 microns, such as from about 20 microns to about 175 microns, such as from about 30 microns to about 150 microns, such as about 35 microns to about 125 microns, such as about 40 microns to about 100 microns, such as about 50 to about 70 microns, or any ranges or values therebetween. In embodiments, the contact angle, also referred to herein as the dynamic contact angle (e.g., non-equilibrium contact angle), for a “fixed” droplet can be desirably controlled to a value of at least about 50°, such as greater than or about 55°, such as greater than or about 60°, such as greater than or about 70°, or any ranges or values therebetween.

The resolution of the pixels within a pixel chart that is used to form a layer, or a portion of a layer, by an additive manufacturing process can be defined by the average “fixed” size of a dispensed droplet. The material composition of a layer, or portion of a layer, can thus be defined by a “dispensed droplet composition”, which a percentage of the total number of pixels within the layer, or portion of the layer, that include droplets of a certain droplet composition. In one example, if a region of a layer of a formed polishing pad is defined as having a dispensed droplet composition of a first dispensed droplet composition of 60%, then 60% percent of the pixels within the region will include a fixed droplet that includes the first material composition. In cases where a portion of a layer contains more than one material composition, it may also be useful to define the material composition of a region within a polishing pad as having a “material composition ratio.” The material composition ratio is a ratio of the number of pixels that have a first material composition disposed thereon to the number of pixels that have a second material composition disposed thereon. In one example, if a region was defined as containing 1,000 pixels, which are disposed across an area of a surface, and 600 of the pixels contain a fixed droplet of a first droplet composition and 400 of the pixels contain a fixed droplet of a second droplet composition then the material composition ratio would include a 3:2 ratio of the first droplet composition to the second droplet composition. In embodiments where each pixel may contain greater than one fixed droplet (e.g., 1.2 droplets per pixel) then the material composition ratio would be defined by the ratio of the number of fixed droplets of a first material to the number of fixed droplets of a second material that are found within a defined region. In one example, if a region was defined as containing 1,000 pixels, and there were 800 fixed droplet of a first droplet composition and 400 fixed droplets of a second droplet composition within the region, then the material composition ratio would be 2:1 for this region of the polishing pad.

The amount of curing of the surface of the dispensed droplet that forms the next underlying layer is a notable polishing pad formation process parameter, since the amount of curing in this “initial dose” affects the surface energy that the subsequent layer of dispensed droplets will be exposed to during the additive manufacturing process. The amount of the initial cure dose is also notable since it will also affect the amount of curing that each deposited layer will finally achieve in the formed polishing pad, due to repetitive exposure of each deposited layer to additional transmitted curing radiation supplied through the subsequently deposited layers, as they are grown thereon. It is generally useful to prevent over curing of a formed layer, since it will affect the material properties of the over cured materials and/or the wettability of the surface of the cured layer to subsequently deposited dispensed droplets in subsequent process. However, in some implementations, the radiation level delivered during the initial cure dose may be varied layer by layer. For example, due to differing dispensed droplet compositions in different layers, the amount of UV radiation exposure in each initial dose may be adjusted to provide a useful level of cure in the currently exposed layer, and to one or more of the underlying layers.

In embodiments, it may be useful to control the droplet composition and the amount of energy delivered from the curing device 320 during the initial curing process, which is a process in which the deposited layer of dispensed droplets are directly exposed to the energy provided by the curing device 320, to cause the layer to only partially cure a targeted amount. In general, it is useful for the initial curing process to predominantly surface cure the dispensed droplet versus bulk cure the dispensed droplet, since controlling the surface energy of the formed layer is notable for controlling the dispensed droplet size. In one example, the amount that a dispensed droplet is partially cured can be defined by the amount of chemical conversion of the materials in the dispensed droplet. In one example, the conversion of the acrylates found in a dispensed droplet that is used to form a urethane polyacrylate containing layer, is defined by a percentage x, which is calculated by the equation:

$$x = 1 - \frac{{( {A}_{C = C} / {A}_{C = O} )}_{x}}{{( {A}_{C = C} / {A}_{C = O} )}_{0}} ,$$

where A_{C═C} and A_{C═O} are the values of the C═C peak at 910 cm⁻¹ and the C═O peaks at 1700 cm-1 found using FT-IR spectroscopy. During polymerization, C═C bonds within acrylates are converted to C—C bond, while C═O within acrylates has no conversion. The intensity of C═C to C═O hence indicates the acrylate conversion rate. The A_{C═C}/A_{C═O} ratio refers to the relative ratio of C═C to C═O bonds within the cured droplet, and thus the (A_{C═C}/A_{C═O})₀ denotes the initial ratio of A_{C═C} to A_{C═O} in the droplet, while (A_{C═C}/A_{C═O})ₓ denotes the ratio of A_{C═C} to A_{C═O} on the surface of the substrate after the droplet has been cured. In some implementations, the amount that a layer is initially cured may be equal to or greater than about 70% of the dispensed droplet. In some implementations, it may be useful to partially cure the material in the dispensed droplet during the initial exposure of the dispensed droplet to the curing energy to a level from about 70% to about 80%, so that the target contact angle of the dispensed droplet may be attained. It is believed that the uncured or partially acrylate materials on top surface are copolymerized with the subsequent droplets, and thus yield cohesion between the layers.

The process of partially curing a dispensed droplet during the initial layer formation process can also be notable to assure that there will be some chemical bonding/adhesion between subsequently deposited layers, due to the presence of residual unbonded groups, such as residual acrylic groups. Since the residual unbonded groups have not been polymerized, they can be involved in forming chemical bonds with a subsequently deposited layer. The formation of chemical bonds between layers can thus increase the mechanical strength of the formed polishing pad in the direction of the layer-by-layer growth during the pad formation process (e.g., Z-direction in FIG. 3B). As noted above, the bonding between layers may thus be formed by both physical and/or chemical forces.

The mixture of the dispensed droplet, or positioning of the dispensed droplets, can be adjusted on a layer-by-layer basis to form layers that individually have tunable properties, and a polishing pad that has targeted pad properties that are a composite of the formed layers. In one example, as shown in FIG. 3B, a mixture of dispensed droplets includes a 50:50 ratio of the dispensed droplets 343 and 347 (or a material composition ratio of 1:1), wherein the dispensed droplet 343 includes at least one different material from the material found in the dispensed droplet 347. Properties of portions of the pad body 202, such as the first polishing elements 204 and/or second polishing elements 206 may be adjusted or tuned according to the ratio and/or distribution of a first composition and a second composition that are formed from the positioning of the dispensed droplets during the deposition process. For example, the weight % of the first composition may be from about 1% by weight based on total composition weight to about 100% based on total composition weight, such as greater than or about 5 wt. %, such as greater than or about 10 wt. %, such as greater than or about 15 wt. %, such as greater than or about 20 wt. %, such as greater than or about 25 wt. %, such as greater than or about 30 wt. %, such as greater than or about 35 wt. %, such as greater than or about 40 wt. %, such as greater than or about 45 wt. %, such as greater than or about 50 wt. %, such as greater than or about 55 wt. %, such as greater than or about 60 wt. %, such as greater than or about 65 wt. %, such as greater than or about 70 wt. %, such as greater than or about 75 wt. %, such as greater than or about 80 wt. %, such as greater than or about 85 wt. %, such as greater than or about 90 wt. %, such as greater than or about 95 wt. %, such as greater than or about 97.5 wt. %, such as greater than or about 99 wt. %, or such as less than or about 95 wt. %, such as less than or about 90 wt. %, such as less than or about 85 wt. %, such as less than or about 80 wt. %, such as less than or about 75 wt. %, such as less than or about 70 wt. %, such as less than or about 65 wt. %, such as less than or about 60 wt. %, such as less than or about 55 wt. %, such as less than or about 50 wt. %, such as less than or about 45 wt. %, such as less than or about 40 wt. %, such as less than or about 35 wt. %, such as less than or about 30 wt. %, such as less than or about 25 wt. %, such as less than or about 20 wt. %, such as less than or about 15 wt. %, such as less than or about 10 wt. %, such as less than or about 5 wt. %, such as less than or about 2.5 wt. %, such as less than or about 1 wt. %, or any ranges or values therebetween.

In a similar fashion, the second composition may be from about 1% by weight based on total composition weight to about 100% based on total composition weight, such as greater than or about 5 wt. %, such as greater than or about 10 wt. %, such as greater than or about 15 wt. %, such as greater than or about 20 wt. %, such as greater than or about 25 wt. %, such as greater than or about 30 wt. %, such as greater than or about 35 wt. %, such as greater than or about 40 wt. %, such as greater than or about 45 wt. %, such as greater than or about 50 wt. %, such as greater than or about 55 wt. %, such as greater than or about 60 wt. %, such as greater than or about 65 wt. %, such as greater than or about 70 wt. %, such as greater than or about 75 wt. %, such as greater than or about 80 wt. %, such as greater than or about 85 wt. %, such as greater than or about 90 wt. %, such as greater than or about 95 wt. %, such as greater than or about 97.5 wt. %, such as greater than or about 99 wt. %, or such as less than or about 95 wt. %, such as less than or about 90 wt. %, such as less than or about 85 wt. %, such as less than or about 80 wt. %, such as less than or about 75 wt. %, such as less than or about 70 wt. %, such as less than or about 65 wt. %, such as less than or about 60 wt. %, such as less than or about 55 wt. %, such as less than or about 50 wt. %, such as less than or about 45 wt. %, such as less than or about 40 wt. %, such as less than or about 35 wt. %, such as less than or about 30 wt. %, such as less than or about 25 wt. %, such as less than or about 20 wt. %, such as less than or about 15 wt. %, such as less than or about 10 wt. %, such as less than or about 5 wt. %, such as less than or about 2.5 wt. %, such as less than or about 1 wt. %, or any ranges or values therebetween.

Depending on the material properties that are required, such as hardness and/or storage modulus, compositions of two or more materials can be mixed in different ratios to achieve a targeted effect. In embodiments, the composition of the first polishing elements 204 and/or second polishing elements 206 is controlled by selecting at least one composition or a mixture of compositions, and size, location, and/or density of the droplets dispensed by one or more printers. Therefore, the electronic controller 305 is generally adapted to position the nozzles 309-310, 311-312 to form a layer that has interdigitated droplets positioned in a targeted density and pattern on the surface of the polishing pad being formed. In embodiments, dispensed droplets may be deposited in such a way as to ensure that each drop is placed in a location where it does not blend with other drops, and thus each remains a discrete material “island” prior to being cured. In some implementations, the dispensed droplets may also be placed on top of prior dispensed droplets within the same layer to increase the build rate or blend material properties. Placement of droplets relative to each other on a surface may also be adjusted to allow partial mixing behavior of each of the dispensed droplets in the layer. In some cases, it may be useful to place the droplets closer together or farther apart to provide mixing of the components in the neighboring droplets, respectively. It has been found that controlling droplet placement relative to other dispensed droplets and the composition of each droplet can influence the mechanical and polishing properties of the formed polishing pad.

In embodiments, dispensed droplets of at least two different curable precursor formulations may be deposited in such a way as to ensure that each drop is placed in a location on the surface where it does not blend with other drops, and thus each remains a discrete material “island” prior to being cured. In embodiments, each of the at least two resin precursor compositions are formulated to provide a material that has a different zeta potential, so that the average zeta potential over a targeted area of a surface of the formed polishing pad can be adjusted and/or controlled by adjusting the percentage of droplets of each type of resin precursor composition within the targeted area. Additionally, or alternately, the placement of the droplets the at least two different resin precursor compositions is adjusted to allow at least partial mixing of each of the dispensed droplets in the deposited layer. Thus, in the case where each of the at least two resin precursor compositions are formulated to provide a material having different zeta potential, and the average zeta potential over a targeted area of a surface of the formed polishing pad can be adjusted and/or controlled by adjusting the amount of intermixing of dispensed droplets of each type of resin precursor composition within at least a portion of the targeted area.

Even though two compositions are generally discussed herein for forming the first polishing elements 204 and/or second polishing elements 206, it should be understood that the present disclosure encompasses forming features on a polishing pad with a plurality of curable precursor formulation that are interconnected via compositional gradients or forming a feature utilizing only one material. In embodiments, the composition of the first polishing elements 204 and/or second polishing elements 206 in a polishing pad are adjusted within a plane parallel to the polishing surface and/or through the thickness of the polishing pad, as discussed further below.

The ability to form compositional gradients and the ability to tune the chemical content locally, within, and across a polishing pad was surprisingly found to be possible utilizing additive manufacturing due at least in part to the surprising low viscosity of the formulations discussed herein, that also maintain their desirable strength and elongation properties. The low viscosity pre-polymer formulations, also referred to as “precursors”, to the formed first polishing elements 204 and second polishing elements 206 found in the pad body 202. The low viscosity pre-polymer formulations enable the delivery of a wide variety of chemistries and discrete compositions that are not available by conventional techniques (e.g., molding and casting), and thus enable controlled compositional transitions or gradients to be formed within different regions of the pad body 202. This is achieved by the addition and mixing of viscosity thinning reactive diluents to high viscosity functional oligomers to achieve the appropriate viscosity formulation, followed by copolymerization of the diluent(s) with the higher viscosity functional oligomers when exposed to a curing energy delivered by the curing device 320. The reactive diluents may also serve as a solvent, thus eliminating the use of inert non-reactive solvents or thinners that must be removed at each stage.

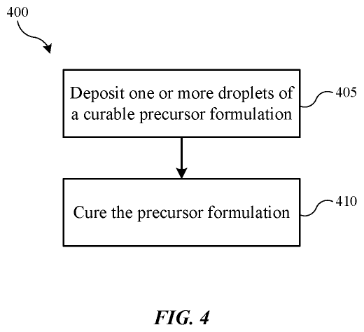

FIG. 4 shows exemplary operations in a method 400 according to some embodiments of the present technology, which may be discussed in relation to printing station 300 as a non-limiting example only. The method may be performed in a variety of polishing chambers or apparatus, including polishing system 100 or printing station 300 described above. Method 400 may include several optional operations, which may or may not be specifically associated with some embodiments of methods according to the present technology. For example, many of the operations are described to provide a broader scope of the structural formation, but are not critical to the technology, or may be performed by alternative methodology as would be readily appreciated. In addition, while the method may describe the formation method vertically from the word line side of the structure to the bit line side of the structure, the other orientation from bit line to word line side may be utilized.

Referring to the precursor delivery section 353 and precursor formulation section 354 of FIG. 3A, in embodiments, a first curable precursor formulation 356, and optionally a second curable precursor formulation 357, and optionally a first porosity-forming agent/emulsifier mixture 352 are mixed with a diluent 358 to form a first printable resin precursor composition 359, which is delivered to reservoir 304B of the printer 306B, and used to form portions of the pad body 202 by depositing one or more droplets of the curable precursor formulation at operation 405. Similarly, a third curable precursor formulation 366, and optionally a fourth curable precursor formulation 367, and optionally a second porosity-forming agent/emulsifier mixture 365 can be mixed with a diluent 368 to form a second printable resin precursor composition 369, which is delivered to reservoir 304A of the printer 306A and used to form another portion of the polishing article body 202. In embodiments, the first curable precursor formulation 356 and the third curable precursor formulation 366 may include a first oligomer, such as a multifunctional oligomer discussed above, the second precursor 357 and the fourth precursor 367 may include one or more reactive monomers, such as a one or more reactive monomers discussed above, the diluent 358 and the diluent 368 each comprise a reactive diluent (e.g., monomer) and/or initiator (e.g., photo-initiator). However, as discussed above, surprisingly, the curable precursor formulation exhibits excellent viscosity when mixed, and may therefore be dispersed from a nozzle after mixing the curable precursor components, as discussed above.

Nonetheless, after depositing one or more droplets of the curable precursor formulation, the precursor formulation may be cured at operation 410 according to one or more curing methods discussed above. Nonetheless, as discussed above, after curing operation 410, depositing operation 405 may be repeated, followed by an additional curing operation 410, until a desired polishing article thickness, topography, shape, or size is achieved. Surprisingly, polishing articles formed utilizing compositions and formulations discussed herein exhibit excellent stability, as illustrated by a ratio of the storage modulus at 30° C., referred to as E30, to the storage modulus at 90° C., referred to as E90, measured utilizing dynamic mechanical analysis (DMA).

Thus, in embodiments, polishing articles according to the present technology may exhibit a ratio of E30 storage modulus to E90 storage modulus of greater than or about 1, such as greater than or about 2, such as greater than or about 3, such as greater than or about 4, such as greater than or about 5, such as greater than or about 7.5, such as greater than or about 10, such as greater than or about 12.5, such as greater than or about 15, such as greater than or about 17.5, such as greater than or about 20, such as greater than or about 22.5, such as greater than or about 25, such as greater than or about 27.5, such as greater than or about 30, such as less than or about 50, such as less than or about 45, such as less than or about 40, such as less than or about 35, such as less than or about 30, such as less than or about 25, such as less than or about 20, or any ranges or values therebetween.

### EXAMPLES

The present technology may be further understood according to the following non limiting examples.

Curable precursor formulations were prepared according to Table 1:

TABLE 1

| | | Aliphatic | | | | | | | |
|---|---|---|---|---|---|---|---|---|---|
| | Aliphatic | urethane | | | | | | | |
| | urethane | acrylate | | 3,3,5- | | | N-Butyl | | |
| | acrylate | oligomer | Iso- | Trimethyl- | N-Vinyl- | N,N- | Acryloyloxy | | |
| Sample | oligomer | 2\hat{ } | bornyl | cyclohexyl | 2-pyrrol | Diethyl | Ethyl | Crosslinking | Crosslinking |
| No | (wt. %)* | (wt. %)* | acrylate | acrylate | idone | acrylamide | Carbamate | Agent | Agent |
| 1 | 32.16 | | 7.06 | 42.16 | 7.84 | 4.9 | | 1.96 | 1.96 |
| 2 | 32 | | 7 | 47 | 10 | | | 2 | |
| 3 | 32 | | 7 | 46 | 10 | | | 3 | |
| 4 | 33 | | 7 | 46 | 10 | | | 2 | |
| Control | 30 | | 33 | 21 | 10 | | | 2 | 2 |
| 1 | | | | | | | | | |
| Control | | 18 | 10 | 27 | 8 | 5 | 15 | 10 | 5 |
| 2 | | | | | | | | | |

*Young's modulus of 189.2 MPa
\hat{ }Young's modulus of 2 MPA

Table 2 depicts the results for the formulations depicted in Table 1. Table 2 depicts the mechanical performance of the cross-linked films of the formulations disclosed in Table 1. Samples printed according to the method discussed herein and were characterized as per ASTM D638—the standard test method for tensile properties of plastics. All samples were exposed to approximately 1 150 mJ/cm² of UV dose using an H-bulb. The samples had a thickness between 2.5 and 2.8 mm.

TABLE 2

| | | Ultimate | | | | | | |
|---|---|---|---|---|---|---|---|---|
| Sample | Viscosity | tensile | Elongation | Young's | | | Tan | Tan |
| No | at 70° C. | strength | at break | modulus | E30 | E90 | Delta | Delta |
| 1 | 12 | 43 | 71 | 2000 | 1756 | 18 | 1.1 | 84 |
| 2 | 12.41 | 46 | 80 | 2000 | 1745 | 15 | 1.18 | 83 |
| 3 | 11.97 | 46 | 80 | 2000 | 1794 | 12 | 1.2 | 80 |
| 4 | 13.6 | 43 | 76 | 2100 | 1655 | 14 | 1.2 | 83 |
| Control | 14.48 | 53 | 17 | 2300 | 1360 | 126 | 1.15 | 98 |
| 1 | | | | | | | | |
| Control | 11.5 | 24.64 | 31.21 | 1102 | Separated | Separated | Separated | Separated |
| 2 | | | | | | | | |

In the preceding description, for the purposes of explanation, numerous details have been set forth to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, nor both limits are included in the smaller ranges is also encompassed within the technology, subject to any specifically excluded limit in the stated range. Where the stated range includes one or both limits, ranges excluding either or both of those included limits are also included.

As used herein and in the appended claims, the singular forms “a”, “an”, and “the” include plural references unless the context clearly dictates otherwise. Thus, for example, reference to “a polishing pad” includes a plurality of such pads, and reference to “the formulation” includes reference to one or more formulations and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A printable resin precursor composition, comprising:
a curable precursor formulation having a viscosity of less than or about 15 cP at 70° comprising
at least one aliphatic urethane acrylate oligomer comprising a Young's Modulus of greater than 2 MPa,
a first reactive monomer having a first glass transition temperature and a first reactive monomer viscosity at 25° C.,
a second reactive monomer having a second glass transition temperature and a second reactive monomer viscosity 25° C., and
a photoinitiator;
wherein an average of the first glass transition temperature and the second glass transition temperature is less than or about 70° C., an average of the first reactive monomer viscosity and the second reactive monomer viscosity is less than or about 50 cP at 25° C., or a combination thereof.

2. The precursor composition of claim 1, wherein the at least one aliphatic urethane acrylate oligomer comprises an elongation at break of greater than or about 50%.

3. The precursor composition of claim 2, wherein the at least one aliphatic urethane acrylate oligomer comprises an elongation at break of greater than or about 75%.

4. The precursor composition of claim 2, wherein the at least one aliphatic urethane acrylate oligomer comprises a tensile strength of greater than or about 5 MPa.

5. The precursor composition of claim 4, wherein the at least one aliphatic urethane acrylate oligomer comprises a Young's Modulus of greater than or about 10 MPa.

6. The precursor composition of claim 2, wherein the at least one aliphatic urethane acrylate oligomer is an aliphatic urethane diacrylate oligomer, an aliphatic polyester urethane diacrylate oligomer, an aliphatic polyether urethane diacrylate oligomer, or a combination thereof.

7. The precursor composition of claim 1, wherein the at least one aliphatic urethane acrylate oligomer has a molecular weight of less than or about 5000 g/mol.

8. The precursor composition of claim 1, wherein the first reactive monomer comprises a viscosity of greater than or about 5 cP at 25° C.

9. The precursor composition of claim 8, wherein the second reactive monomer comprises a viscosity of less than or about 5 cP at 25° C.

10. The precursor composition of claim 8, wherein the second reactive monomer comprises a viscosity of less than or about 2.5 cP at 25° C.

11. The precursor composition of claim 1, wherein the first reactive monomer comprises a glass transition temperature of greater than or about 55°.

12. The precursor composition of claim 11, wherein the first reactive monomer comprises a glass transition temperature of greater than or about 80°.

13. The precursor composition of claim 1, wherein the second reactive monomer comprises a glass transition temperature of less than or about 55°.

14. The precursor composition of claim 1, wherein the second reactive monomer comprises a glass transition temperature of less than or about 40°.

15. The precursor composition of claim 14, wherein the first reactive monomer, the second reactive monomer, or both the first and second reactive monomer is isobornyl acrylate, 3,3,5-trimethylcyclohexyl acrylate, N-vinyl-2-pyrrolidone, N,N-diethyl acrylamide, (2-[[(butylamino)carbonyl]oxy]ethyl acrylate), acrylic acid, methacrylic acid, 2-carboxyethyl acrylate, 2-hydroxyethyl methacrylate, 2-hydroxyethyl acrylate, N-(2-hydroxyethyl)acrylamide, tetrahydrofurfuryl acrylate, cyclohexyl acrylate, cyclic trimethylolpropane formal acrylate, pentaerythritol tetra (3-mercaptopropionate), ethylene Glycol Bis(3-mercaptopropionate), or a combination thereof.

16. The precursor composition of claim 15, wherein the first reactive monomer, the second reactive monomer, or both the first and second reactive monomer is isobornyl acrylate, 3,3,5-trimethylcyclohexyl acrylate, N-vinyl-2-pyrrolidone, N,N-diethyl acrylamide, (2-[[(butylamino)carbonyl]oxy]ethyl acrylate), N-(2-hydroxyethyl)acrylamide, or a combination thereof.

17. The precursor composition of claim 15, wherein the first reactive monomer is isobornyl acrylate, N,N-diethyl acrylamide, N-(2-hydroxyethyl)acrylamide, or a combination thereof.

18. The precursor composition of claim 17, wherein the second reactive monomer is 3,3,5-trimethylcyclohexyl acrylate, N-vinyl-2-pyrrolidone, (2-[[(butylamino)carbonyl]oxy]ethyl acrylate), or a combination thereof.

19. A printable resin precursor composition, comprising:
a curable precursor formulation having a viscosity of less than or about 15 cP at 70° comprising
a first aliphatic urethane acrylate oligomer comprising a Young's Modulus of greater than or about 10 MPa,
a first reactive monomer having a first glass transition temperature and a first reactive monomer viscosity,
a second reactive monomer having a second glass transition temperature and a second reactive monomer viscosity, and
a photoinitiator.

20. A method of forming a polishing article, comprising:
depositing one or more droplets of a curable precursor formulation onto a support with an additive manufacturing system, wherein the curable precursor formulation exhibits a viscosity of less than or about 15 cP at 70° and includes
at least one aliphatic urethane acrylate oligomer comprising a Young's Modulus of greater than or about 5 MPa,
a first reactive monomer having a first glass transition temperature and a first reactive monomer viscosity,
a second reactive monomer having a second glass transition temperature and a second reactive monomer viscosity, and
a photoinitiator; and
curing the precursor formulation, forming one or more solidified polymeric layers.
